(19) United States
(12) Patent Application Publication
(10) Pub. No.: US 2011/0164684 A1
(43) Pub. Date: Jul. 7, 2011

(54) IMAGE PROCESSING APPARATUS AND METHOD

(75) Inventors: Kazushi Sato, Kanagawa (JP); Yoichi Yagasaki, Tokyo (JP)

(73) Assignee: SONY CORPORATION, Tokyo (JP)

(21) Appl. No.: 13/119,717

(22) PCT Filed: Sep. 24, 2009
(86) PCT No.: PCT/JP2009/066491

§ 371 Date: Mar. 17, 2011

(30) Foreign Application Priority Data
Sep. 24, 2008 (JP) 2008-243960

(51) Int. Cl. H04N 7/12

(52) U.S. Cl. 375/240.16; 375/E07.104; 375/E07.243

(57) ABSTRACT

The present invention relates to an image processing apparatus and method capable of suppressing an increase in the number of computations.

By using a motion vector tmmv₀ searched for in a reference frame of a reference picture number ref_id=0, an MRF search center calculation unit 77 calculates a motion search center mv_{c} in the reference frame of a reference picture number ref_id=1, whose distance in the time axis to the target frame is next close to a reference picture number ref_id=0. A template motion prediction and compensation unit 76 performs a motion search in a predetermined range E in the surroundings of the obtained search center mv_{c} of the reference frame of the reference picture number ref_id=1, performs a compensation process, and generates a prediction image. The present invention can be applied to, for example, an image coding device that performs coding in accordance with the H.264/AVC method.

### TECHNICAL FIELD

The present invention relates to an image processing apparatus and method and, more particularly, relates to an image processing apparatus and method in which an increase in the number of computations is suppressed.

### BACKGROUND ART

In recent years, a technology has become popular in which an image is compressed and coded, is packetized, and is transmitted by using a method, such as MPEG (Moving Picture Experts Group) 2, or H.264 and MPEG-4 Part 10 (Advanced Video Coding) (hereinafter referred to as H.264/AVC), and is decoded on the receiving side. As a result, it is possible for a user to view a moving image with high quality.

By the way, in the MPEG2 method, a motion prediction and compensation process of ½-pixel accuracy is performed by a linear interpolation process. However, in the H.264/AVC method, a prediction and compensation process of ¼-pixel accuracy using a 6-tap FIR (Finite Impulse Response Filter) filter is performed.

Furthermore, in the MPEG2 method, in the case of a frame motion compensation mode, a motion prediction and compensation process is performed in units of 16×16 pixels, and in the case of a field motion compensation mode, a motion prediction and compensation process is performed in units of 16×8 pixels on each of a first field and a second field.

In comparison, in the H.264/AVC method, motion prediction and compensation can be performed in such a manner that a block size is variable. That is, in the H.264/AVC method, one macroblock composed of 16×16 pixels can be divided into one of partitions of 16×16, 16×8, 8×16, or 8×8 so as to have independent motion vector information. Furthermore, an 8×8 partition can be divided into one of sub-partitions of 8×8, 8×4, 4×8, or 4×4 so as to have independent motion vector information.

However, in the H.264/AVC method, as a result of the above-described motion prediction and compensation process of ¼-pixel accuracy, and a block variable motion prediction and compensation process being performed, an enormous amount of motion vector information is generated. If this is coded as is, the coding efficiency is caused to decrease.

Accordingly, a method has been proposed in which searching a decoded image for an area of an image having a high correlation with a decoded image of a template area that is adjacent to an area of an image to be coded in a predetermined position relationship and that is a portion of the decoded image is performed, and a prediction is performed on the basis of the relationship between the found area and the predetermined position (see PTL 1).

In this method, since a decoded image is used for matching, by determining the search range in advance, it is possible to perform the same process in a coding device and a decoding device. That is, as a result of the above-described prediction and compensation process being performed also in the decoding device, image compression information from the coding device does not need to have motion vector information. Consequently, it is possible to suppress a decrease in the coding efficiency.

### CITATION LIST

### Patent Literature

PTL 1: Japanese Unexamined Patent Application Publication No. 2007-43651

### SUMMARY OF INVENTION

### Technical Problem

By the way, in the H.264/AVC method, a method of a multi-reference frame is prescribed in which a plurality of reference frames are stored in a memory, so that a different reference frame can be referred to for each target block.

However, when the technology of PTL 1 is applied to this multi-reference frame, it is necessary to perform a motion search for all the reference frames. As a result, an increase in the number of computations is caused to occur in not only the coding device, but also the decoding device.

The present invention has been made in view of such circumstances, and aims to suppress an increase in the number of computations.

### Solution to Problem

An image processing apparatus according to an aspect of the present invention includes: a search center calculation unit that uses a motion vector of a first target block of a frame, the motion vector being searched for in a first reference frame of the first target block, so as to calculate a search center in a second reference frame whose distance to the frame in the time axis is next close to the first reference frame; and a motion prediction unit that searches for a motion vector of the first target block by using a template that is adjacent to the first target block in a predetermined position relationship and that is generated from a decoded image in a predetermined search range in the surroundings of the search center in the second reference frame, the search center being calculated by the search center calculation unit.

The search center calculation unit can calculate the search center in the second reference frame by performing scaling on the motion vector of the first target block using the distance in the time axis to the frame, the motion vector being searched for by the motion prediction unit in the first reference frame.

When a distance in the time axis between the frame and the first reference frame of a reference picture number ref_id=k−1 is denoted as tₖ₋₁, a distance between the frame and the second reference frame of a reference picture number ref_id=k is denoted as tₖ, and a motion vector of the first target block searched for by the motion prediction unit in the first reference frame is denoted as tmmvₖ₋₁, the search center calculation unit can calculate a search center mv_{c} as

$${mv}_{c} = \frac{{t}_{k}}{{t}_{k - 1}} \cdot {tmmv}_{k - 1} , \qquad [ Math . 1 ]$$

and
the motion prediction unit can search for the motion vector of the first target block in a predetermined search range in the surroundings of the search center mv_{c} in the second reference frame, the search center being calculated by the search center calculation unit.

The search center calculation unit can perform a calculation of the search center mv_{c} by only a shift operation by approximating a value of tₖ/tₖ₋₁ in the form of N/2^{M} (N and M are integers).

A POC (Picture Order Count) can be used as distances tₖ and tₖ₋₁ in the time axis.

When there is no parameter corresponding to the reference picture number ref_id in image compression information, processing can be performed starting with a reference frame in the order of closeness to the frame in the time axis for both the forward and backward predictions.

The motion prediction unit can search for the motion vector of the first target block in a predetermined range by using the template in the first reference frame whose distance in the time axis to the frame is closest.

When the second reference frame is a long term reference picture, the motion prediction unit can search for the motion vector of the first target block in a predetermined range by using the template in the second reference frame.

The image processing apparatus can further include a decoding unit that decodes information on a coded motion vector; and a prediction image generation unit that generates a prediction image by using the motion vector of a second target block of the frame, the motion vector being decoded by the decoding unit.

The motion prediction unit can search for the motion vector of a second target block of the frame by using the second target block, and the image processing apparatus can further include an image selection unit that selects one of a prediction image based on the motion vector of the first target block, the motion vector being searched for by the motion prediction unit, and a prediction image based on the motion vector of the second target block, the motion vector being searched for by the motion prediction unit.

An image processing method according to an aspect of the present invention includes the steps of: using, with an image processing apparatus, a motion vector of a target block, the motion vector being searched for in a first reference frame of the target block of a frame, so as to calculate a search center in a second reference frame whose distance in the time axis to a frame is next close to the first reference frame; and searching for a motion vector of the target block in a predetermined search range in the surroundings of the calculated search center in the second reference frame by using a template that is adjacent to the target block in a predetermined position relationship and that is generated from a decoded image.

In an aspect of the present invention, by using the motion vector of a target block that is searched for in a first reference frame of a target block of a frame, a search center in a second reference frame whose distance in the time axis to the frame is next close to the first reference frame is calculated. Then, in a predetermined search range in the surroundings of the search center in the calculated second reference frame, the motion vector of the target block is searched for by using a template that is adjacent to the target block in a predetermined position relationship and that is generated from the decoded image.

### Advantageous Effects of Invention

As described in the foregoing, according to an aspect of the present invention, it is possible to code or decode an image. Furthermore, according to an aspect of the present invention, it is possible to suppress an increase in the number of computations.

### BRIEF DESCRIPTION OF DRAWINGS

FIG. 1 is a block diagram illustrating the configuration of an embodiment of an image coding device to which the present invention is applied.

FIG. 2 illustrates a variable-block-size motion prediction and compensation process.

FIG. 3 illustrates a motion prediction and compensation process of ¼-pixel accuracy.

FIG. 4 illustrates a motion prediction and compensation method of a multi-reference frame.

FIG. 5 is a flowchart illustrating a coding process of the image coding device of FIG. 1.

FIG. 6 is a flowchart illustrating a prediction process of step S21 of FIG. 5.

FIG. 7 is a flowchart illustrating an intra-prediction process of step S31 of FIG. 6.

FIG. 8 illustrates the direction of intra-prediction.

FIG. 9 illustrates intra-prediction.

FIG. 10 is a flowchart illustrating an inter-motion prediction process of step S32 of FIG. 6.

FIG. 11 illustrates an example of a method of generating motion vector information.

FIG. 12 is a flowchart illustrating an inter-template motion prediction process of step S33 of FIG. 6.

FIG. 13 illustrates an inter-template matching method.

FIG. 14 illustrates in detail processes of steps S71 to S73 of FIG. 12.

FIG. 15 illustrates the assignment of a default reference picture number Ref_id in the H.264/AVC method.

FIG. 16 illustrates an example of the assignment of a reference picture number Ref_id replaced by a user.

FIG. 17 illustrates multi-hypothesis motion compensation.

FIG. 18 is a block diagram illustrating the configuration of an embodiment of an image decoding device to which the present invention is applied.

FIG. 19 is a flowchart illustrating a decoding process of the image decoding device of FIG. 18.

FIG. 20 is a flowchart illustrating the prediction process of step S138 of FIG. 19.

FIG. 21 is a flowchart illustrating an inter-template motion prediction process of step S175 of FIG. 20.

FIG. 22 illustrates an example of an extended block size.

FIG. 23 is a block diagram illustrating an example of the main configuration of a television receiver to which the present invention is applied.

FIG. 24 is a block diagram illustrating an example of the main configuration of a mobile phone to which the present invention is applied.

FIG. 25 is a block diagram illustrating an example of the main configuration of a hard-disk recorder to which the present invention is applied.

FIG. 26 is a block diagram illustrating the main configuration of a camera to which the present invention is applied.

### DESCRIPTION OF EMBODIMENTS

Embodiments of the present invention will be described below with reference to the drawings.

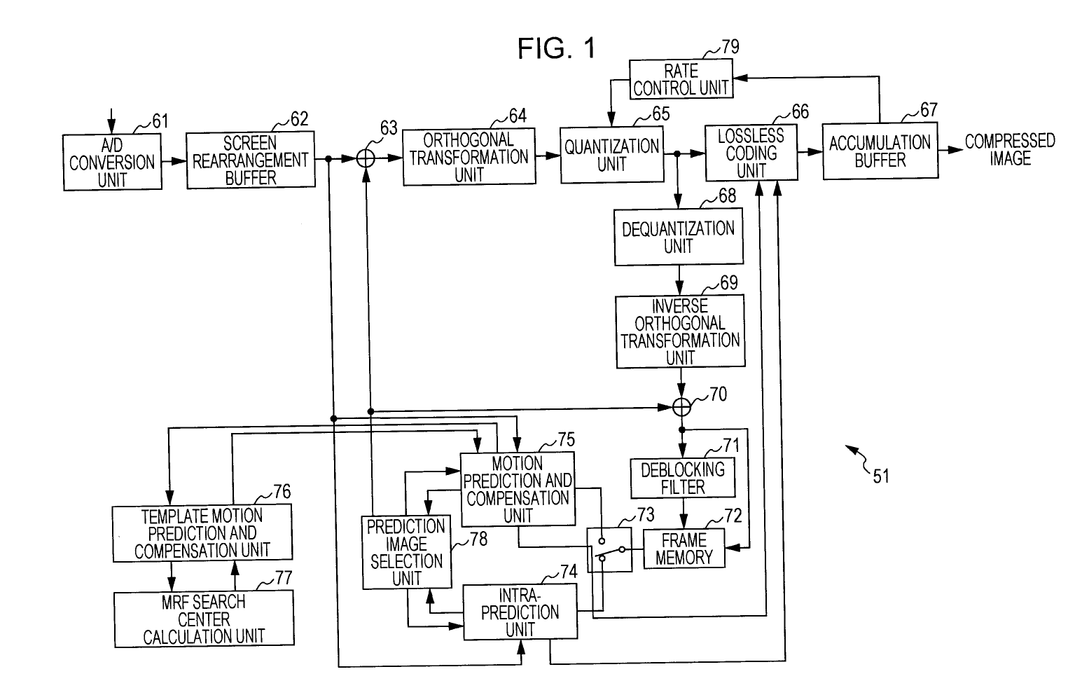

FIG. 1 shows the configuration of an embodiment of an image coding device of the present invention. An image coding device 51 includes an A/D conversion unit 61, a screen rearrangement buffer 62, a computation unit 63, an orthogonal transformation unit 64, a quantization unit 65, a lossless coding unit 66, an accumulation buffer 67, a dequantization unit 68, an inverse orthogonal transformation unit 69, a computation unit 70, a deblocking filter 71, a frame memory 72, a switch 73, an intra-prediction unit 74, a motion prediction and compensation unit 75, a template motion prediction and compensation unit 76, an MRF (Multi-Reference Frame) search center calculation unit 77, a prediction image selection unit 78, and a rate control unit 79.

The image coding device 51 compresses and codes an image by, for example, the H.264 and MPEG-4 Part 10 (Advanced Video Coding) (hereinafter referred to as H.264/AVC) method.

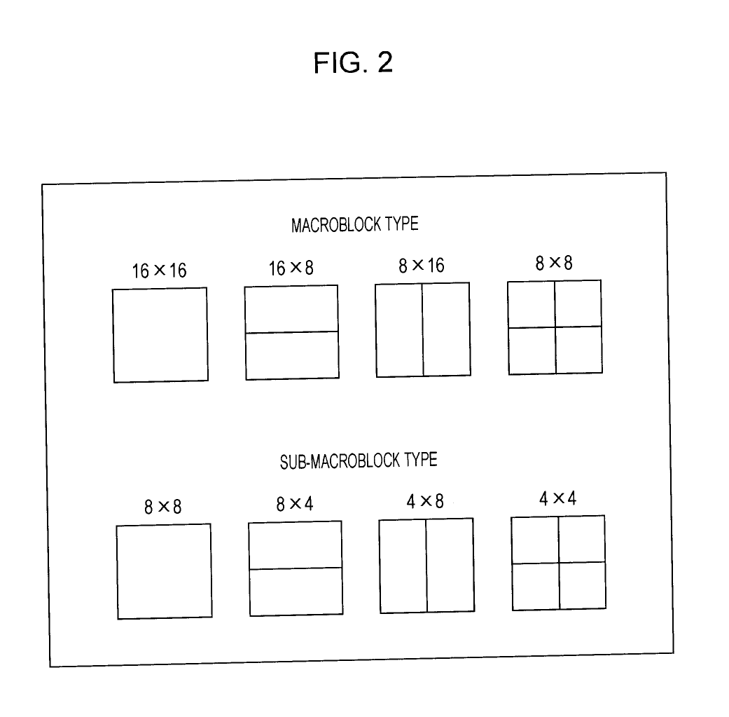

In the H.264/AVC method, a block size is made variable, and motion prediction and compensation is performed. That is, in the H.264/AVC method, as shown in FIG. 2, one macroblock composed of 16×16 pixels can be divided into partitions of one of 16×16 pixels, 16×8 pixels, 8×16 pixels, and 8×8 pixels, and each can have independent motion vector information. Furthermore, as shown in FIG. 2, the partition of 8×8 pixels can be divided into sub-partitions of one of 8×8 pixels, 8×4 pixels, 4×8 pixels, and 4×4 pixels, and each can have independent motion vector information.

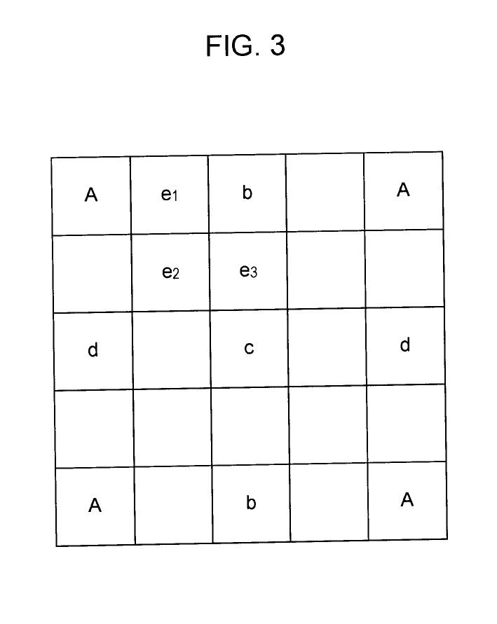

Furthermore, in the H.264/AVC method, a prediction and compensation process of ¼-pixel accuracy using a 6-tap FIR (Finite Impulse Response Filter) filter is used. A description will be given, with reference to FIG. 3, of a prediction and compensation process of decimal pixel accuracy in the H.264/AVC method.

In an example of FIG. 3, a position A indicates the position of an integer accuracy pixel, positions b, c, and d each indicate the position of ½-pixel accuracy, and positions e1, e2, and e3 each indicate the position of ¼-pixel accuracy. First, in the following, Clip( ) is defined as in the following Equation (1).

$$\begin{matrix}[ Math . 2 ] & \\ Clip 1 ( a ) = \{ \begin{matrix}0 ; & if ( a < 0 ) \\ a ; & otherwise \\ max\_pix ; & if ( a > max\_pix )\end{matrix} & ( 1 )\end{matrix}$$

Meanwhile, when the input image has 8-bit accuracy, the value of max_pix becomes 255.

The pixel values in positions b and d are generated as in the following Equation (2) by using a 6-tap FIR filter.

[Math. 3]

F=A₋₂−5·A₋₁+20·A₀+20·A₁−5·A₂+A₃

b,d=Clip1((F+16)>>5) (2)

The pixel value in the position c is generated as in the following Equation (3) by using a 6-tap FIR filter in the horizontal direction and in the vertical direction.

[Math. 4]

F=b₋₂−5·b₋₁+20·b₀+20·b₁−5·b₂+b₃

or

F=d₋₂−5·d₋₁+20·d₀+20·d₁−5·d₂+d₃

c=Clip1((F+512)>>10) (3)

Meanwhile, the Clip process is performed only once finally after both a product-sum process in the horizontal direction and a product-sum process in the vertical direction are performed.

The positions e1 to e3 are generated by linear interpolation as in the following Equation (4).

[Math. 5]

e₁=(A+b+1)>>1

e₂=(b+d+1)>>1

e₃=(b+c+1)>>1 (4)

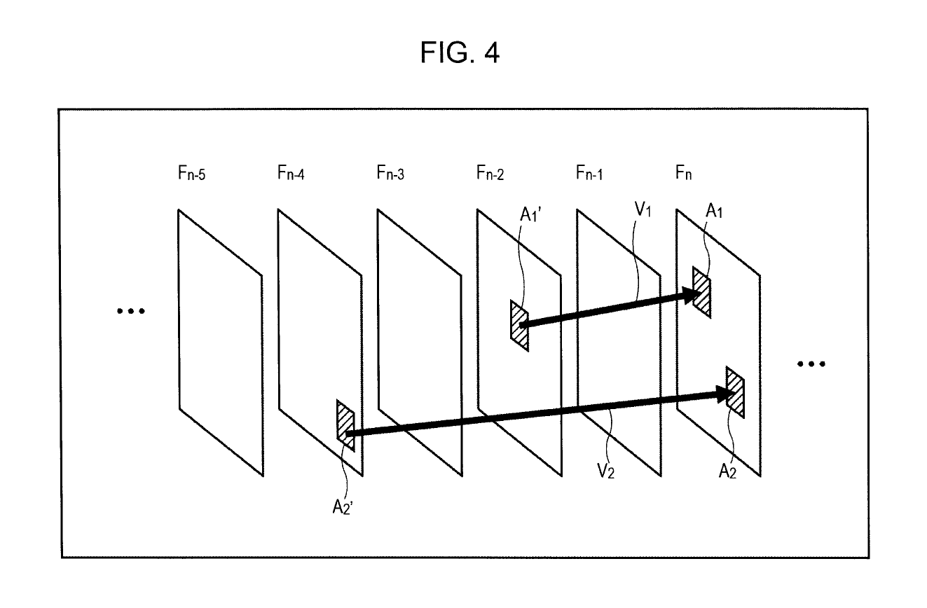

Furthermore, in the H.264/AVC method, a motion prediction and compensation method of a multi-reference frame has been determined. A description will be given, with reference to FIG. 4, of a prediction and compensation process of a multi-reference frame in the H.264/AVC method.

In an example of FIG. 4, a target frame Fn to be coded from now, and coded frames Fn-5, . . . , Fn-1 are shown. The frame Fn-1 is one frame before the target frame Fn in the time axis, the frame Fn-2 is two frames before the target frame Fn, and the frame Fn-3 is three frames before the target frame Fn. Furthermore, the frame Fn-4 is four frames before the target frame Fn, and the frame Fn-5 is five frames before the target frame Fn. In general, the closer to the target frame Fn in the time axis the frame is, the smaller the reference picture number (ref_id) attached. That is, the frame Fn-1 has the smallest reference picture number, and the reference picture number decreases in the order of Fn-2, . . . , Fn-5.

For the target frame Fn, a block A1 and a block A2 are shown. The block A1 is assumed to be correlated with a block A1′ of two before the frame Fn-2, and a motion vector V1 is searched for. Furthermore, a block A2 is assumed to be correlated with a block A1′ of four before the frame Fn-4, and a motion vector V2 is searched for.

As described above, in the H.264/AVC method, a plurality of reference frames can be stored in a memory, so that different reference frames can be referred to in one frame (picture). That is, it is possible for each block to have independent reference frame information (reference picture number (ref_id)) in one picture, such as, for example, the block A1 referring to the frame Fn-2, and the block A2 referring to the frame Fn-4.

Referring back to FIG. 1, the A/D conversion unit 61 performs A/D conversion on an input image, outputs the image to the screen rearrangement buffer 62, whereby it is stored. The screen rearrangement buffer 62 rearranges the stored images of the frames of the display order in the order of frames for coding in accordance with a GOP (Group of Pictures).

The computation unit 63 subtracts, from the image read from the screen rearrangement buffer 62, a prediction image from the intra-prediction unit 74, or a prediction image from the motion prediction and compensation unit 75, which is selected by the prediction image selection unit 78, and outputs the difference information thereof to the orthogonal transformation unit 64. The orthogonal transformation unit 64 performs an orthogonal transform, such as discrete cosine transform or Karhunen Loeve transform, on the difference information from the computation unit 63, and outputs a transform coefficient. The quantization unit 65 quantizes the transform coefficient output by the orthogonal transformation unit 64.

The quantized transform coefficient, which is an output of the quantization unit 65, is input to the lossless coding unit 66, whereby lossless coding, such as variable-length coding or arithmetic coding, is performed, and the quantized transform coefficient is compressed.

The lossless coding unit 66 obtains information on intra-prediction from the intra-prediction unit 74, and obtains information on inter-prediction and inter-template prediction from the motion prediction and compensation unit 75. The lossless coding unit 66 codes the quantized transform coefficient, and codes information on intra-prediction, information on the inter-prediction and inter-template process, and the like so as to form a part of the header information in the compressed image. The lossless coding unit 66 supplies the coded data to the accumulation buffer 67, whereby it is stored.

For example, in the lossless coding unit 66, a lossless coding process, such as variable-length coding, for example, CAVLC (Context-Adaptive Variable-length coding), or such as arithmetic coding, for example, CABAC (Context-Adaptive Binary Arithmetic Coding), which is stipulated in the H.264/AVC method, is performed.

The accumulation buffer 67 outputs the data supplied from the lossless coding unit 66 as a compressed image that is coded by the H.264/AVC method to, for example, a recording device (not shown) at a subsequent stage or to a transmission path.

Furthermore, the quantized transform coefficient, which is output from the quantization unit 65, is also input to the dequantization unit 68, whereby the quantized transform coefficient is dequantized. Thereafter, furthermore, the quantized transform coefficient is inversely orthogonally transformed in the inverse orthogonal transformation unit 69. The inversely orthogonally transformed output is added to the prediction image supplied from the prediction image selection unit 78 by the computation unit 70, thereby forming an image that is locally decoded. The deblocking filter 71 removes the block distortion of the decoded image, and thereafter supplies the decoded image to the frame memory 72, whereby it is stored. An image before it is subjected to a deblocking filtering process by the deblocking filter 71 is also supplied to the frame memory 72, whereby the image is stored.

The switch 73 outputs the reference image stored in the frame memory 72 to the motion prediction and compensation unit 75 or the intra-prediction unit 74.

In this image coding device 51, for example, an I picture, a B picture, and a P picture from the screen rearrangement buffer 62 are supplied as images used for intra-prediction (also referred to as an intra-process) to the intra-prediction unit 74. Furthermore, the B picture and the P picture that are read from the screen rearrangement buffer 62 are supplied as images used for inter-prediction (also referred to as an inter-process) to the motion prediction and compensation unit 75.

On the basis of the image used for intra-prediction, which is read from the screen rearrangement buffer 62, and the reference image supplied from the frame memory 72, the intra-prediction unit 74 performs an intra-prediction process of all the candidate intra-prediction modes so as to generate a prediction image.

In that case, the intra-prediction unit 74 calculates cost function values for all the candidate intra-prediction modes, and selects an intra-prediction mode in which the calculated cost function value gives a minimum value as the optimum intra-prediction mode.

The intra-prediction unit 74 supplies the prediction image generated in the optimum intra-prediction mode and the cost function value to the prediction image selection unit 78. In a case where the prediction image generated in the optimum intra-prediction mode by the prediction image selection unit 78 is selected, the intra-prediction unit 74 supplies information on the optimum intra-prediction mode to the lossless coding unit 66. The lossless coding unit 66 codes this information so as to form a part of the header information in the compressed image.

The motion prediction and compensation unit 75 performs motion prediction and compensation processes of all the candidate inter-prediction modes. That is, on the basis of the image used for an inter-process, which is read from the screen rearrangement buffer 62, and the reference image supplied from the frame memory 72 through the switch 73, the motion prediction and compensation unit 75 detects motion vectors of all the candidate inter-prediction modes, performs motion prediction and compensation processes on the reference image on the basis of the motion vector, thereby generating a prediction image.

Furthermore, the motion prediction and compensation unit 75 supplies the image on which the inter-process is performed, which is read from the screen rearrangement buffer 62, and the reference image supplied from the frame memory 72 through the switch 73, to the template motion prediction and compensation unit 76.

In addition, the motion prediction and compensation unit 75 calculates cost function values for all the candidate inter-prediction modes. The motion prediction and compensation unit 75 determines, as the optimum inter-prediction mode, a prediction mode in which the minimum value is given among the calculated cost function values for the inter-prediction modes, and the cost function value for the inter-template process mode, which is calculated by the template motion prediction and compensation unit 76.

The motion prediction and compensation unit 75 supplies the prediction image generated in the optimum inter-prediction mode, and the cost function value to the prediction image selection unit 78. In a case where the prediction image generated in the optimum inter-prediction mode by the prediction image selection unit 78 is selected, the motion prediction and compensation unit 75 outputs information on the optimum inter-prediction mode and information (motion vector information, flag information, reference frame information, and the like) appropriate for the optimum inter-prediction mode to the lossless coding unit 66. The lossless coding unit 66 performs a lossless coding process, such as variable-length coding or arithmetic coding, on information from the motion prediction and compensation unit 75, and inserts the information to the header part of the compressed image.

On the basis of the image from the screen rearrangement buffer 62, on which the inter-process is performed, and the reference image supplied from the frame memory 72, the template motion prediction and compensation unit 76 performs a motion prediction and compensation process of the inter-template process mode so as to generate a prediction image.

In that case, with regard to the reference frame closest to the target frame in the time axis among the plurality of reference frames described above with reference to FIG. 4, the template motion prediction and compensation unit 76 performs a motion search of the inter-template process mode in a preset predetermined range, performs a compensation process, and generates a prediction image. On the other hand, regarding the reference frames other than the reference frame closest to the target frame, the template motion prediction and compensation unit 76 performs a motion search of the inter-template process mode in a predetermined range in the surroundings of the search center calculated by the MRF search center calculation unit 77, performs a compensation process, and generates a prediction image.

Therefore, in a case where a motion search for the reference frame other than the reference frame closest to the target frame in the time axis from among the plurality of reference frames is to be performed, the template motion prediction and compensation unit 76 supplies the image on which inter-coding is performed, the image being read from the screen rearrangement buffer 62, and the reference image supplied from the frame memory 72, to the MRF search center calculation unit 77. Meanwhile, at this time, the motion vector information that has been found with regard to the reference frame in the time axis of one before the reference frame for the object of the search is supplied to the MRF search center calculation unit 77.

Furthermore, the template motion prediction and compensation unit 76 determines that the prediction image having the minimum prediction error among the prediction images that have been generated with regard to the plurality of reference frames to be a prediction image for the target block. Then, the template motion prediction and compensation unit 76 calculates a cost function value for the inter-template process mode regarding the determined prediction image, and supplies the calculated cost function value and the prediction image to the motion prediction and compensation unit 75.

The MRF search center calculation unit 77 calculates the search center of the motion vector in the reference frame for the object of the search by using the motion vector information that has been found with regard to the reference frame in the time axis of one before the reference frame for the object of the search from among the plurality of reference frames. Specifically, the MRF search center calculation unit 77 performs scaling of the motion vector information that has been found with regard to the reference frame in the time axis of one before the reference frame for the object of the search by using the distance in the time axis to the target frame to be coded from now, thereby calculating the motion vector search center in the reference frame for the object of the search.

On the basis of each cost function value output from the intra-prediction unit 74 or the motion prediction and compensation unit 75, the prediction image selection unit 78 determines the optimum prediction mode from among the optimum intra-prediction mode and the optimum inter-prediction mode, selects the prediction image of the determined optimum prediction mode, and supplies the prediction image to the computation units 63 and 70. At this time, the prediction image selection unit 78 supplies the selection information of the prediction image to the intra-prediction unit 74 or the motion prediction and compensation unit 75.

On the basis of the compressed images stored in the accumulation buffer 67, the rate control unit 79 controls the rate of the quantization operation of the quantization unit 65 so that an overflow or an underflow does not occur.

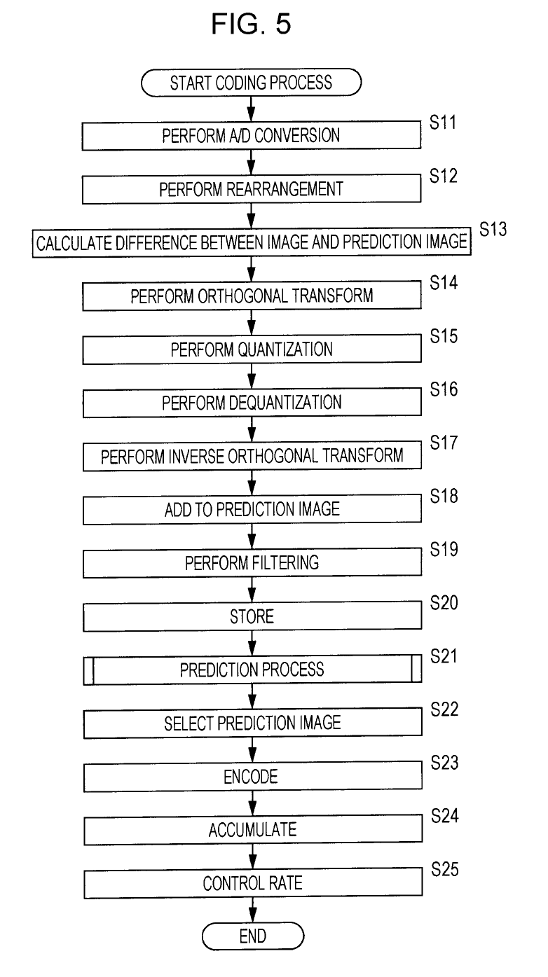

Next, a description will be given, with reference to the flowchart of FIG. 5, of a coding process of the image coding device 51 of FIG. 1.

In step S11, the A/D conversion unit 61 performs A/D conversion on an input image. In step S12, the screen rearrangement buffer 62 stores the image supplied from the A/D conversion unit 61, and performs rearrangement from the order in which the pictures are displayed to the order in which the pictures are coded.

In step S13, the computation unit 63 calculates the difference between the image rearranged in step S12 and the prediction image. The prediction image is supplied to the computation unit 63 through the prediction image selection unit 78 from the motion prediction and compensation unit 75 when inter-prediction is performed, and from the intra-prediction unit 74 when intra-prediction is performed.

The data amount of the difference data is smaller than the original image data. Therefore, when compared to the case in which the image is directly coded, the amount of data can be compressed.

In step S14, the orthogonal transformation unit 64 orthogonally transforms the difference information supplied from the computation unit 63. Specifically, an orthogonal transform, such as a discrete cosine transform or a Karhunen Loeve transform, is performed, and a transform coefficient is output. In step S15, the quantization unit 65 quantizes the transform coefficient. For performing this quantization, the rate is controlled, as will be described in the process of step S25 (to be described later).

The difference information that has been quantized in the manner described above is locally decoded in the following manner. That is, in step S16, the dequantization unit 68 dequantizes the transform coefficient that has been quantized by the quantization unit 65 in accordance with the characteristics corresponding to the characteristics of the quantization unit 65. In step S17, the inverse orthogonal transformation unit 69 inversely orthogonally transforms the transform coefficient that has been dequantized by the dequantization unit 68 in accordance with the characteristics corresponding to the characteristics of the orthogonal transformation unit 64.

In step S18, the computation unit 70 adds the prediction image input through the prediction image selection unit 78 to the difference information that has been locally decoded, and generates an image (image corresponding to the input to the computation unit 63) that has been locally decoded. In step S19, the deblocking filter 71 performs the filtering of the image output from the computation unit 70. As a result, block distortion is removed. In step S20, the frame memory 72 stores the filtered image. Meanwhile, an image on which the filtering process has not been performed by the deblocking filter 71 is also supplied from the computation unit 70 and stored in the frame memory 72.

In step S21, the intra-prediction unit 74, the motion prediction and compensation unit 75, and the template motion prediction and compensation unit 76 each perform a prediction process for the image. That is, in step S21, the intra-prediction unit 74 performs an intra-prediction process of the intra-prediction mode, and the motion prediction and compensation unit 75 performs a motion prediction and compensation process of the inter-prediction mode. Furthermore, the template motion prediction and compensation unit 76 performs a motion prediction and compensation process of the inter-template process mode.

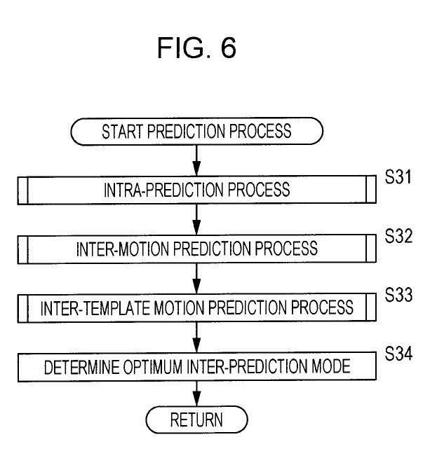

The details of the prediction process in step S21 will be described later with reference to FIG. 6. As a result of this process, the prediction processes in all the candidate prediction modes are performed, and the cost function values in all the candidate prediction modes are calculated. Then, on the basis of the calculated cost function value, the optimum intra-prediction mode is selected, and the prediction image that is generated by intra-prediction of the optimum intra-prediction mode and the cost function value thereof are supplied to the prediction image selection unit 78. Furthermore, on the basis of the calculated cost function value, the optimum inter-prediction mode is determined from among the inter-prediction mode and the inter-template process mode, and the prediction image generated in the optimum inter-prediction mode and the cost function value thereof are supplied to the prediction image selection unit 78.

In step S22, on the basis of the cost function values output from the intra-prediction unit 74 and the motion prediction and compensation unit 75, the prediction image selection unit 78 determines one of the optimum intra-prediction mode and the optimum inter-prediction mode to be the optimum prediction mode. Then, the prediction image selection unit 78 selects the prediction image of the determined optimum prediction mode, and supplies the prediction image to the computation units 63 and 70. This prediction image is used for the arithmetic operation of steps S13 and S18 in the manner described above.

Meanwhile, the selection information of this prediction image is supplied to the intra-prediction unit 74 or the motion prediction and compensation unit 75. In a case where the prediction image of the optimum intra-prediction mode is selected, the intra-prediction unit 74 supplies information (that is, intra-prediction mode information) on the optimum intra-prediction mode to the lossless coding unit 66.

In a case where the prediction image of the optimum inter-prediction mode is selected, the motion prediction and compensation unit 75 outputs information on the optimum inter-prediction mode, and information (motion vector information, flag information, reference frame information, and the like) appropriate for the optimum inter-prediction mode to the lossless coding unit 66.

Furthermore, specifically, when the prediction image based on the inter-prediction mode has been selected as the optimum inter-prediction mode, the motion prediction and compensation unit 75 outputs the inter-prediction mode information, the motion vector information, and the reference frame information to the lossless coding unit 66.

On the other hand, when the prediction image based on the inter-template process mode has been selected as the optimum inter-prediction mode, the motion prediction and compensation unit 75 outputs only the inter-template process mode information to the lossless coding unit 66. That is, since the motion vector information, and the like do not need to be sent to the decoding side, these are not output to the lossless coding unit 66. Therefore, it is possible to reduce the motion vector information in the compressed image.

In step S23, the lossless coding unit 66 codes the transform coefficient that has been output and quantized by the quantization unit 65. That is, the difference image is subjected to lossless coding, such as variable-length coding or arithmetic coding, and is compressed. At this time, the intra-prediction mode information from the intra-prediction unit 74, which has been input to the lossless coding unit 66 in step S22 above, information (prediction mode information, motion vector information, reference frame information, and the like) appropriate for the optimum inter-prediction mode from the motion prediction and compensation unit 75, and the like are coded and attached to the header information.

In step S24, the accumulation buffer 67 accumulates the difference image as a compressed image. The compressed image accumulated in the accumulation buffer 67 is read as appropriate, and is transmitted to the decoding side through the transmission path.

In step S25, on the basis of the compressed image stored in the accumulation buffer 67, the rate control unit 79 controls the rate of the quantization operation of the quantization unit 65 so that an overflow or an underflow does not occur.

Next, a description will be given, with reference to the flowchart of FIG. 6, of a prediction process in step S21 of FIG. 5.

In a case where the image to be processed, which is supplied from the screen rearrangement buffer 62, is an image of a block on which the intra-process is performed, decoded images that are referred to are read from the frame memory 72 and is supplied to the intra-prediction unit 74 through the switch 73. In step S31, on the basis of these images, the intra-prediction unit 74 performs intra-prediction on the pixels of the block to be processed in all the candidate intra-prediction modes. Meanwhile, as decoded pixels that are referred to, pixels that have not been deblock-filtered by the deblocking filter 71 are used.

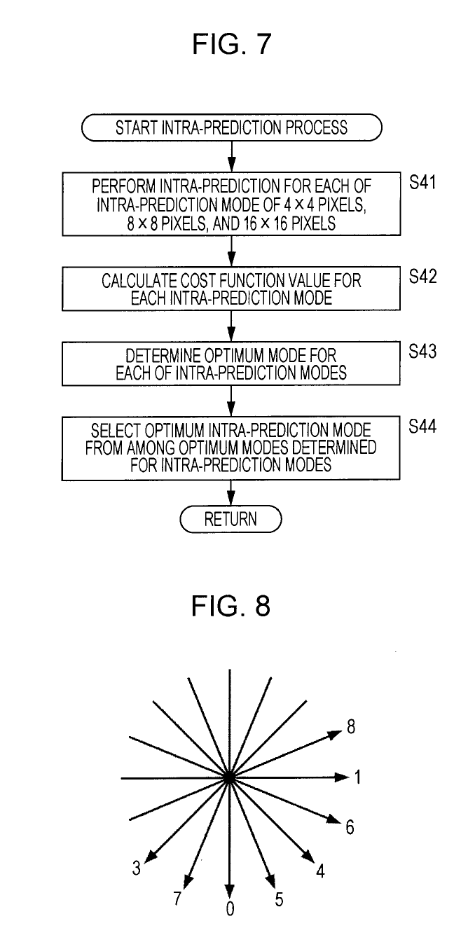

The details of the intra-prediction process in step S31 will be described later with reference to FIG. 7. As a result of this process, intra-prediction is performed in all the candidate intra-prediction modes, and cost function values are calculated for all the candidate intra-prediction modes. Then, on the basis of the calculated cost function value, the optimum intra-prediction mode is selected, and the prediction image generated by the intra-prediction of the optimum intra-prediction mode and the cost function value thereof are supplied to the prediction image selection unit 78.

In a case where the image to be processed, which is supplied from the screen rearrangement buffer 62, is an image on which the inter-process is performed, images that are referred to are read from the frame memory 72 and are supplied to the motion prediction and compensation unit 75 through the switch 73. In step S32, on the basis of these images, the motion prediction and compensation unit 75 performs an inter-motion prediction process. That is, the motion prediction and compensation unit 75 performs a motion prediction process of all the candidate inter-prediction modes by referring to the image supplied from the frame memory 72.

The details of the inter-motion prediction process in step S32 will be described later with reference to FIG. 10. This process enables a motion prediction process to be performed in all the candidate inter-prediction modes and enables a cost function value to be calculated for all the candidate inter-prediction modes.

Furthermore, in a case where the image to be processed, which is supplied from the screen rearrangement buffer 62, is an image on which the inter-process is performed, images to which a reference are made is read from the frame memory 72 and are also supplied to the template motion prediction and compensation unit 76 through the switch 73 and the motion prediction and compensation unit 75. On the basis of these images, in step S33, the template motion prediction and compensation unit 76 performs an inter-template motion prediction process.

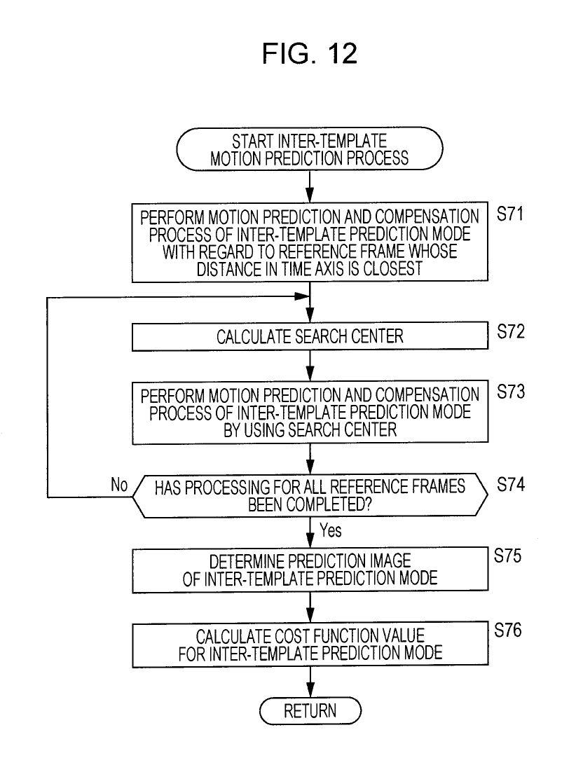

The details of the inter-template motion prediction process in step S33 will be described later with reference to FIG. 12. This process enables a motion prediction process to be performed in the inter-template process mode and a cost function value to be calculated for the inter-template process mode. Then, the prediction image generated by the motion prediction process of the inter-template process mode and the cost function value thereof are supplied to the motion prediction and compensation unit 75. Meanwhile, in a case where there is information (for example, prediction mode information and the like) appropriate for the inter-template process mode, the information is also supplied to the motion prediction and compensation unit 75.

In step S34, the motion prediction and compensation unit 75 compares the cost function value for the inter-prediction mode, which is calculated in step S32, with the cost function value for the inter-template process mode, which is calculated in step S33, and determines the prediction mode in which the minimum value is given as the optimum inter-prediction mode. Then, the motion prediction and compensation unit 75 supplies the prediction image that is generated in the optimum inter-prediction mode and the cost function value thereof to the prediction image selection unit 78.

Next, a description will be given, with reference to the flowchart of FIG. 7, of an intra-prediction process in step S31 of FIG. 6. Meanwhile, in the example of FIG. 7, a description will be given by using the case of a luminance signal as an example.

In step S41, the intra-prediction unit 74 performs intra-prediction on each intra-prediction mode of 4×4 pixels, 8×8 pixels, and 16×16 pixels.

The intra-prediction modes for a luminance signal include nine types of prediction modes in units of blocks of 4×4 pixels and 8×8 pixels, and four types of prediction modes in units of macroblocks of 16×16 pixels, and the intra-prediction mode for a color-difference signal includes four types of prediction modes in units of 8×8 pixels. The intra-prediction mode for a color-difference signal can be set independently of the intra-prediction mode for a luminance signal. Regarding the intra-prediction mode of 4×4 pixels and 8×8 pixels for a luminance signal, one intra-prediction mode is defined for each block of the luminance signals of 4×4 pixels and 8×8 pixels. Regarding the intra-prediction mode of 16×16 pixels for a luminance signal and the intra-prediction mode for a color-difference signal, one prediction mode is defined with respect to one macroblock.

The types of prediction mode correspond to the directions indicated by numbers 0, 1, and 3 to 8 of FIG. 8. The prediction mode 2 is an average value prediction.

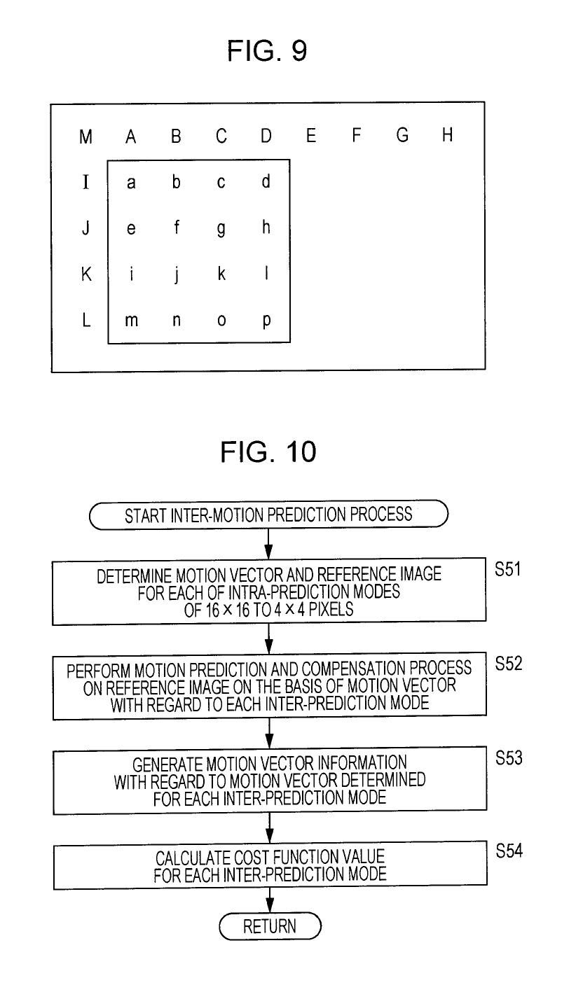

For example, the case of the intra 4×4 prediction mode will be described with reference to FIG. 9. In a case where an image (for example, pixels a to p) to be processed, which is read from the screen rearrangement buffer 62, is an image of a block on which the intra-process is performed, decoded images (pixels A to M) that are referred to are read from the frame memory 72, and are supplied to the intra-prediction unit 74 through the switch 73.

On the basis of these images, the intra-prediction unit 74 performs intra-prediction on pixels of a block to be processed. As a result of this intra-prediction process being performed in each intra-prediction mode, a prediction image in each intra-prediction mode is generated. Meanwhile, as decoded pixels (pixels A to M) that is referred to, pixels that have not been deblock-filtered by the deblocking filter 71 are used.

In step S42, the intra-prediction unit 74 calculates a cost function value for each of the intra-prediction modes of 4×4 pixels, 8×8 pixels, and 16×16 pixels. Here, the cost function value is calculated on the basis of one of a high complexity mode and a low complexity mode, as specified in a JM (Joint Model), which is reference software in the H.264/AVC method.

That is, in the high complexity mode, as the process of step S41, up to the coding process is tentatively performed in all the candidate prediction modes, the cost function value represented in the following Equation (5) is calculated in each prediction mode, and the prediction mode in which the minimum value thereof is given is selected as the optimum prediction mode.

Cost(Mode)=D+λ·R (5)

D is the difference (distortion) between the original image and the decoded image, R is the amount of generated code containing up to the orthogonal transform coefficient, and λ is a Lagrange multiplier that is given as a function for a quantization parameter QP.

On the other hand, in the low complexity mode, as the process of step S41, with regard to all the candidate prediction modes, a prediction image is generated, and up to the header bit, such as motion vector information, prediction mode information, flag information, and the like, are calculated, the cost function value represented in the following Equation (6) is calculated for each prediction mode, and the prediction mode in which the minimum value thereof is given is selected by determining the prediction mode to be the optimum prediction mode.

Cost(Mode)=D+QPtoQuant(QP)·Header_Bit (6)

D is the difference (distortion) between the original image and the decoded image, Header_Bit is the header bit for the prediction mode, and QPtoQuant is the function given as the function of the quantization parameter QP.

In the low complexity mode, prediction images are only generated for all the prediction modes, and a coding process and a decoding process do not need to be performed. Consequently, the number of computations is small.

In step S43, the intra-prediction unit 74 determines an optimum mode for each of the intra-prediction modes of 4×4 pixels, 8×8 pixels, and 16×16 pixels. That is, as described above with reference to FIG. 8, in the case of the intra 4×4 prediction mode and the intra 8×8 prediction mode, the number of types of prediction mode is nine, and in the case of the intra 16×16 prediction mode, the number of types of prediction mode is four. Therefore, on the basis of the cost function value calculated in step S42, the intra-prediction unit 74 determines, the optimum intra 4×4 prediction mode, the optimum intra 8×8 prediction mode, and the optimum intra 16×16 prediction mode from among the prediction modes.

In step S44, the intra-prediction unit 74 selects the optimum intra-prediction mode on the basis of the cost function value calculated in step S42 from among the optimum modes that are determined for the intra-prediction modes of 4×4 pixels, 8×8 pixels, and 16×16 pixels. That is, the mode in which the cost function value is the minimum value is selected as the optimum intra-prediction mode from among the optimum modes that are determined for 4×4 pixels, 8×8 pixels, and 16×16 pixels. Then, the intra-prediction unit 74 supplies the prediction image generated in the optimum intra-prediction mode and the cost function value thereof to the prediction image selection unit 78.

Next, a description will be given, with reference to the flowchart of FIG. 10, of an inter-motion prediction process of step S32 of FIG. 6.

In step S51, the motion prediction and compensation unit 75 determines a motion vector and a reference image for each of the eight types of inter-prediction modes composed of 16×16 pixels to 4×4 pixels described above with reference to FIG. 2. That is, the motion vector and the reference image are each determined with regard to a block to be processed in each inter-prediction mode.

In step S52, the motion prediction and compensation unit 75 performs a motion prediction and compensation process on the reference image on the basis of the motion vector determined in step S51 with regard to each of the eight types of inter-prediction modes composed of 16×16 pixels to 4×4 pixels. This motion prediction and compensation process enables a prediction image in each inter-prediction mode to be generated.

In step S53, the motion prediction and compensation unit 75 generates motion vector information to be attached to the compressed image with regard to the motion vector determined in each of eight types of inter-prediction modes composed of 16×16 pixels to 4×4 pixels.

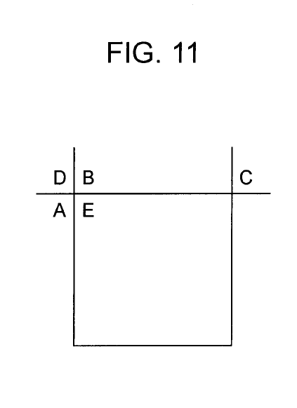

Here, a description will be given, with reference to FIG. 11, of a method of generating motion vector information in accordance with the H.264/AVC method. In an example of FIG. 11, a target block E (for example, 16×16 pixels) to be coded from now, and blocks A to D that have already been coded and that are adjacent to the target block E are shown.

That is, the block D is adjacent to the upper left area of the target block E, the block B is adjacent to the upper area of the target block E, the block C is adjacent to the upper right area of the target block E, and the block A is adjacent to the left area of the target block E. Meanwhile, the fact that the blocks A to D are not divided indicates that each block is a block having one of the configurations of 16×16 pixels to 4×4 pixels described above with reference to FIG. 2.

For example, motion vector information for X (=A, B, C, D, E) is represented as mvₓ. First, prediction motion vector information pmv_{E} for the target block E is generated as in the following Equation (7) by median prediction by using the motion vector information regarding the blocks A, B, and C.

pmv_{E}=med(mv_{A},mv_{B},mv_{C}) (7)

In a case where the motion vector information regarding the block C cannot be used (unavailable) due to reasons, such as being an end of a screen frame or being not yet coded, the motion vector information regarding the block C is substituted by the motion vector information regarding the block D.

Data mvd_{E} that is attached to the header part of the compressed image as the motion vector information for the target block E is generated as in the following Equation (8) by using pmv_{E}.

mvd_{E}=mv_{E}−pmv_{E} (8)

Meanwhile, in practice, processing is performed on the components in each of the horizontal direction and the vertical direction of the motion vector information independently of each other.

As described above, by generating the prediction motion vector information and by attaching the difference between the prediction motion vector information and the motion vector information, which is generated in accordance with the correlation with the adjacent block, to the header part of the compressed image, the motion vector information can be reduced.

The motion vector information generated in the manner described above is also used to calculate the cost function value in the subsequent step S54. In a case where the corresponding prediction image is finally selected by the prediction image selection unit 78, the prediction image, together with the prediction mode information and the reference frame information, is output to the lossless coding unit 66.

Referring back to FIG. 10, in step S54, the motion prediction and compensation unit 75 calculates a cost function value represented by Equation (5) or Equation (6) described above with respect to each of the eight types of inter-prediction modes composed of 16×16 pixels to 4×4 pixels. The cost function value calculated here is used when the optimum inter-prediction mode is determined in step S34 described above in FIG. 6.

Next, a description will be given, with reference to the flowchart of FIG. 12, of an inter-template motion prediction process of step S33 of FIG. 6.

In step S71, the template motion prediction and compensation unit 76 performs a motion prediction and compensation process of the inter-template process mode with regard to the reference frame whose distance in the time axis to the target frame is closest. That is, the template motion prediction and compensation unit 76 searches for a motion vector in accordance with the inter-template matching method with regard to the reference frame whose distance in the time axis to the target frame is closest. Then, the template motion prediction and compensation unit 76 performs a motion prediction and compensation process on the reference image on the basis of the found motion vector, and generates a prediction image.

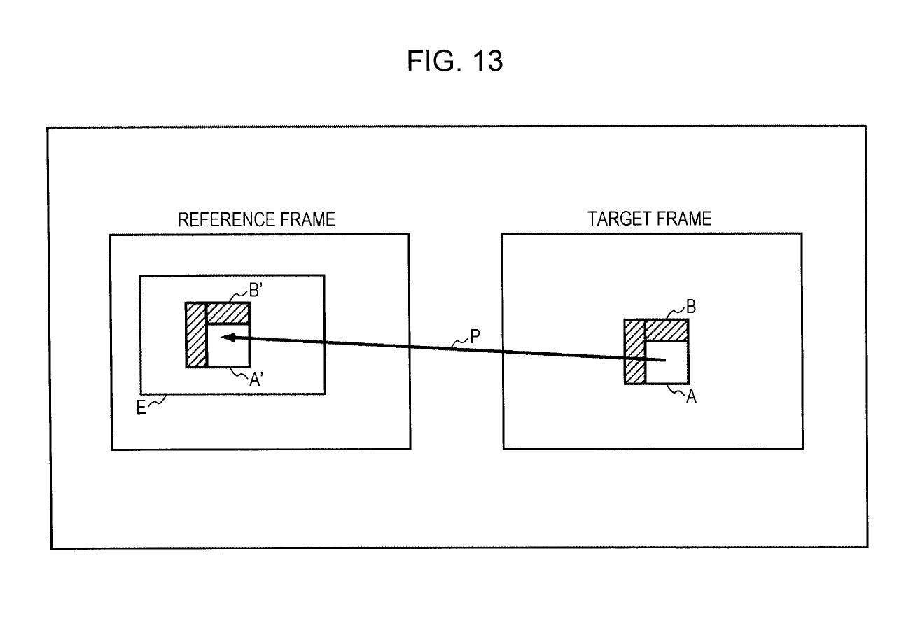

The inter-template matching method will be specifically described with reference to FIG. 13.

In an example of FIG. 13, a target frame for the object of coding and a reference frame that is referred to when a motion vector is searched for are shown. In the target frame, a target block A to be coded from now, and a template area B that is adjacent to the target block A and that is composed of coded pixels are shown. That is, when a coding process is performed in the raster scan order, as shown in FIG. 13, the template area B is an area positioned on the left and upper side of the target block A, and is an area in which a decoded image is stored in the frame memory 72.

The template motion prediction and compensation unit 76 performs a template matching process by using, for example, an SAD (Sum of Absolute Difference) as a cost function, in a predetermined search range E in the reference frame, and searches for an area B′ in which a correlation with the pixel value of the template area B is highest. Then, the template motion prediction and compensation unit 76 searches for a motion vector P for the target block A by using the block A′ corresponding to the found area B′ as a prediction image for the target block A.

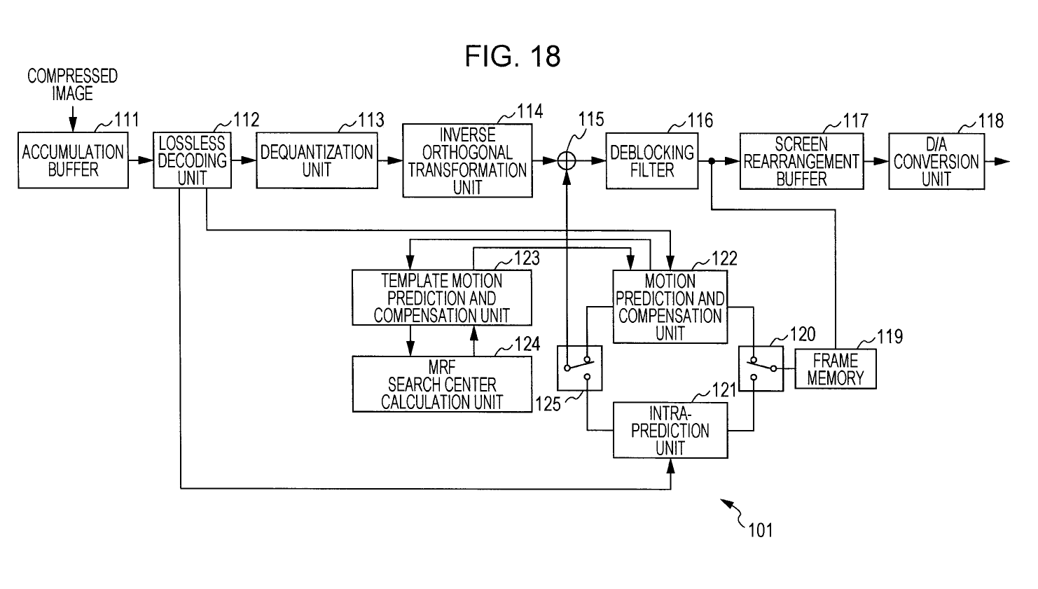

As described above, for the motion vector search process based on the inter-template matching method, a decoded image is used for a template matching process. Therefore, by determining in advance the predetermined search range E, the same process can be performed in the image coding device 51 of FIG. 1 and an image decoding device 101 of FIG. 18 to be described later. That is, also in the image decoding device 101, by configuring a template motion prediction and compensation unit 123, it is not necessary to send the information on the motion vector P for the target block A to the image decoding device 101. Thus, the motion vector information in the compressed image can be reduced.

Meanwhile, the sizes of the block and the template in the inter-template process mode are arbitrary. That is, similarly to the motion prediction and compensation unit 75, the process can be performed by fixing one block size from among the eight types of the block sizes composed of 16×16 pixels to 4×4 pixels described above with reference to FIG. 2, and can be performed by assuming all the block sizes as candidates. The template size may be variable in accordance with the block size, and may be fixed.

Here, in the H.264/AVC method, in the manner described above with reference to FIG. 4, a plurality of reference frames can be stored in a memory. In each block of one target frame, a reference can be made to different reference frames. However, performance of motion prediction in accordance with the inter-template matching method with regard to all the reference frames that are candidates of multi-reference frames will increase an increase in the number of computations.

Accordingly, in a case where a motion search for a reference frame other than the reference frame that is closest to the target frame in the time axis among the plurality of reference frames is to be performed, in step S72, the template motion prediction and compensation unit 76 causes the MRF search center calculation unit 77 to calculate the search center of the reference frame. Then, in step S73, the template motion prediction and compensation unit 76 performs a motion search in a predetermined range composed of several pixels in the surroundings of the search center calculated by the MRF search center calculation unit 77, performs a compensation process, and generates a prediction image.

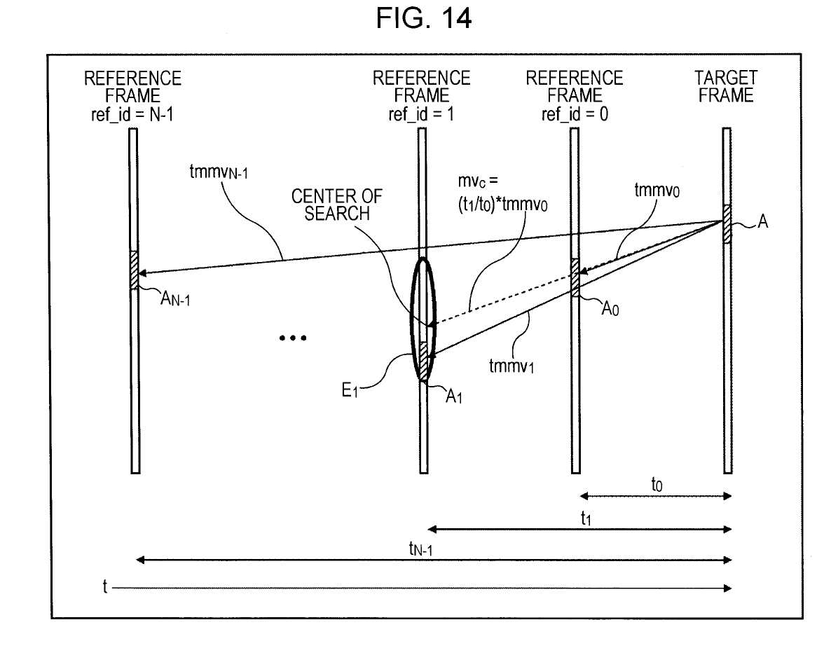

A description will be described in detail, with reference to FIG. 14, of processes of steps S71 to S73 above. In an example of FIG. 14, the time axis t indicates the elapsed time. Starting in sequence from the left, a reference frame of the reference picture number ref_id=N−1, a reference frame of the reference picture number ref_id=1, a reference frame of the reference picture number ref_id=0, and a target frame to be coded from now are shown. That is, the reference frame of the reference picture number ref_id=0 is a reference frame whose distance in the time axis t to the target frame is closest from among the plurality of reference frames. In comparison, the reference frame of the reference picture number ref_id=N−1 is a reference frame whose distance in the time axis t to the target frame is farthest from among the plurality of reference frames.

In step S71, the template motion prediction and compensation unit 76 performs a motion prediction and compensation process of the inter-template process mode between the target frame and the reference frame of the reference picture number ref_id=0, whose distance in the time axis to the target frame is closest.

First, this process of step S71 enables an area B₀ having the highest correlation with the pixel value of the template area B that is adjacent to the target block A in the target frame and that is composed of already coded pixels to be searched for in a predetermined search range of the reference frame of the reference picture number ref_id=0. As a result, a search is made for a motion vector tmmv₀ for the target block A by using a block A₀ corresponding to the found area B₀ as a prediction image for the target block A.

Next, in step S72, the MRF search center calculation unit 77 calculates the motion search center in the reference frame of the reference picture number ref_id=1, whose distance in the time axis is next close to the target frame, by using the found motion vector tmmv₀ in step S71.

This process of step S72 enables the search center mv_{c} that forms Equation (9) to be obtained by considering a distance t₀ in the time axis t between the target frame and the reference frame of the reference picture number ref_id=0, and a distance t₁ in the time axis t between the target frame and the reference frame of the reference picture number ref_id=1. That is, as indicated using a dotted line in FIG. 14, the search center my, is such that a motion vector tmmv₀ obtained in the reference frame that is one frame before in the time axis is scaled in accordance with a distance in the time axis with respect to the reference frame of the reference picture number ref_id=1. Meanwhile, in practice, this search center my, is rounded off to integer pixel accuracy and is used.

$$\begin{matrix}[ Math . 6 ] & \\ {mv}_{c} = \frac{{t}_{1}}{{t}_{0}} \cdot {tmmv}_{0} & ( 9 )\end{matrix}$$

Meanwhile, Equation (9) needs division. However, in practice, by approximating t₁/t₀ in the form of N/2^{M} by setting M and N as integers, the division can be realized by a shift operation including round off to the nearest whole number.

Furthermore, in the H.264/AVC method, since information corresponding to the distances t₀ and t₁ in the time axis t with respect to the target frame does not exist in the compressed image, a POC (Picture Order Count), which is information indicating the output order of pictures, is used.

Then, in step S73, the template motion prediction and compensation unit 76 performs a motion search in a predetermined range E₁ in the surroundings of the search center mv_{c} in the reference frame of the reference picture number ref_id=1 obtained in Equation (9), performs a compensation process, and generates a prediction image.

As a result of this process of step S73, in the predetermined range E₁ in the surroundings of the search center mv_{c} in the reference frame of the reference picture number ref_id=1, a search is made for an area B₁ that is adjacent to the target block A in the target frame and that has the highest correlation with the pixel value of the template area B composed of coded pixels. As a result, a search is made for a motion vector tmmv₁ for the target block A by using the block A₁ corresponding to the found area B₁ as a prediction image for the target block A.

As described above, the range in which the motion vector is searched for is limited to a predetermined range in which the search center, at which scaling is performed on the motion vector that has been obtained in the reference frame that is one frame before in the time axis, by using the distance in the time axis to the target frame with respect to the next reference frame, is at the center. As a result, in the reference frame of the reference picture number ref_id=1, the reduction in the number of computations can be realized while minimizing a decrease in the coding efficiency.

Next, in step S74, the template motion prediction and compensation unit 76 determines whether or not processing for all the reference frames has been completed. When it is determined in step S74 that the processing has not yet been completed, the process returns to step S72, and processing at and subsequent to step S72 is repeated.

That is, this time, in step S72, by using the motion vector tmmv₁ searched for in the previous step S73, the MRF search center calculation unit 77 calculates the motion search center in the reference frame of the reference picture number ref_id=2, whose distance in the time axis to the target frame is close, which is next close to the reference picture number ref_id=1, which is close to the target frame.

As a result of this process of step S72, a search center mv_{c} that forms Equation (10) is obtained by considering a distance t₁ in the time axis t between the target frame and the reference frame of the reference picture number ref_id=1 and a distance t₂ in the time axis t between the target frame and the reference frame of the reference picture number ref_id=2.

$$\begin{matrix}[ Math . 7 ] & \\ {mv}_{c} = \frac{{t}_{2}}{{t}_{1}} \cdot {tmmv}_{1} & ( 10 )\end{matrix}$$

Then, in step S73, the template motion prediction and compensation unit 76 performs a motion search in a predetermined range E₂ in the surroundings of the search center mv_{c} obtained in Equation (10), performs a compensation process, and generates a prediction image.

These processes are repeated in sequence in the end up to the last reference frame, which is reference picture number ref_id=N−1, that is, until it is determined in step S74 that the processes for all the reference frames have been completed. As a result, the motion vector tmmv₀ of the reference frame of the reference picture number ref_id=0 to the motion vector tmmv_{N-1} of the reference frame of the reference picture number ref_id=N−1 are obtained.

Meanwhile, if Equation (9) and Equation (10) are represented by an arbitrary integer k (0<k<N), these yield equation (11). That is, if, by using the motion vector tmmvₖ₋₁ obtained in the reference frame of the reference picture number ref_id=k-1, the distance between the target frame and the reference frame of the reference picture number ref_id=k−1 and the distance between the target frame and the reference frame of the reference picture number ref_id=k in the time axis t are denoted as tₖ₋₁ and tₖ, respectively, the search center of the reference frame of the reference picture number ref_id=k is represented by Equation (11).

$$\begin{matrix}[ Math . 8 ] & \\ {mv}_{c} = \frac{{t}_{k}}{{t}_{k - 1}} \cdot {tmmv}_{k - 1} & ( 11 )\end{matrix}$$

When it is determined in step S74 that the processing for all the reference frames has been completed, the process proceeds to step S75. In step S75, the template motion prediction and compensation unit 76 determines the prediction image of the inter-template mode for the target block from among the prediction images for all the reference frames obtained in the process of step S71 or S73.

That is, the prediction image in which the prediction error obtained by using an SAD (Sum of Absolute Difference) or the like is smallest from among the prediction images for all the reference frames is determined to be the prediction image for the target block.

In step S75, the template motion prediction and compensation unit 76 calculates a cost function value represented by Equation (5) or Equation (6) described above with respect to the inter-template process mode. The cost function value calculated here, together with the determined prediction image, is supplied to the motion prediction and compensation unit 75, and is used to determine the optimum inter-prediction mode in step S34 of FIG. 6 above.

As in the foregoing, in the image coding device 51, when a motion prediction and compensation process in the inter-template process mode of the multi-reference frame is to be performed, by using the motion vector information of one before the reference frame in the time axis, the search center in the reference frame is obtained, and a motion search is performed by using the search center. As a result, the reduction in the number of computations can be realized while minimizing a decrease in the coding efficiency.

Furthermore, these processes are performed not only by the image coding device 51, but also by the image decoding device 101 of FIG. 18. Therefore, in the target block of the inter-template process mode, not only the motion vector information but also the reference frame information does not need to be sent. Thus, the coding efficiency can be improved while minimizing.

Meanwhile, in the H.264/AVC method, assignment of the reference picture number ref_id is performed by default. The replacement of the reference picture number ref_id can also be performed by a user.

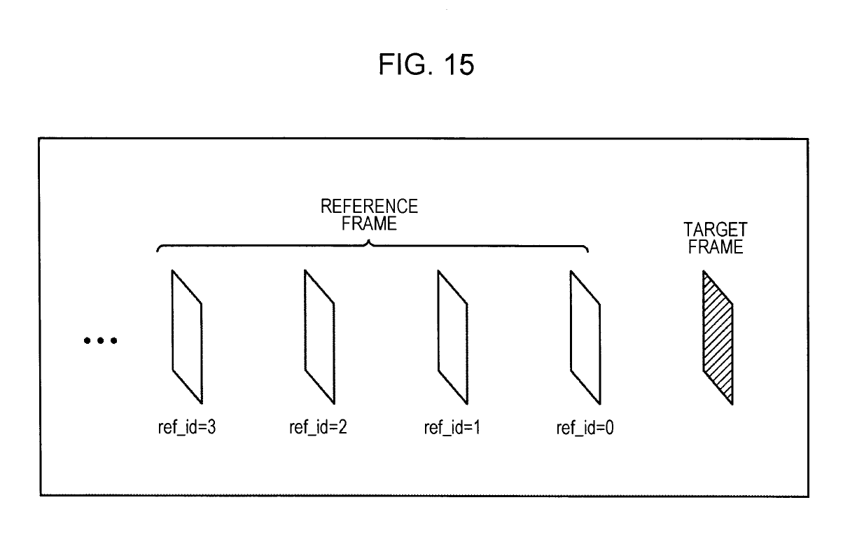

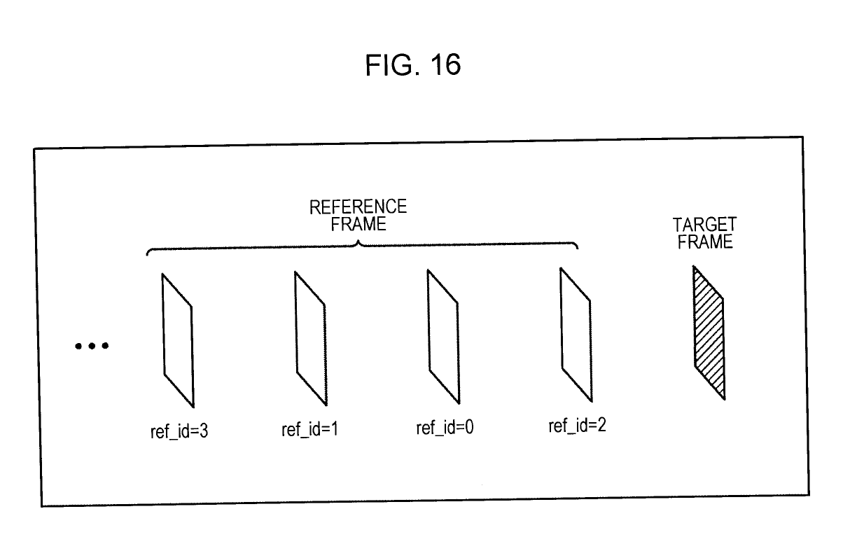

FIG. 15 illustrates the default assignment of reference picture numbers ref_id in the H.264/AVC method. FIG. 16 illustrates an example of the assignment of reference picture numbers ref_id replaced by the user. FIGS. 15 and 16 show a state in which time progresses from left to right.

In the default example of FIG. 15, the reference picture number ref_id is assigned in the order, with respect to time, of the closeness of the reference picture to the target picture to be coded from now.

That is, the reference picture number ref_id=0 is assigned to the reference picture immediately before (with respect to time) the target picture, and the reference picture number ref_id=1 is assigned to the reference picture two pictures before the target picture. The reference picture number ref_id=2 has been assigned to the reference picture of three before the target picture, and the reference picture number ref_id=3 has been assigned to the reference picture of four before the target picture.

On the other hand, in an example of FIG. 16, the reference picture number ref_id=0 has been assigned to the reference picture of two before the target picture, and the reference picture number ref_id=1 has been assigned to the reference picture of three before the target picture. Furthermore, the reference picture number ref_id=2 has been assigned to the reference picture of one before the target picture, and the reference picture number ref_id=3 has been assigned to the reference picture of four before the target picture.

When an image is to be coded, the case in which a smaller reference picture number ref_id is assigned to the picture that is referred to more often makes it possible to decrease the amount of code of the compressed image. Therefore, usually, as in a default of FIG. 15, by assigning the reference picture number ref_id in the order of the reference picture that, with respect to time, is closest to the target picture to be coded from now, it is possible to reduce the amount of code required for the reference picture number ref_id.

However, in a case where, for example, the prediction efficiency using the immediately previous picture is extremely low for the reason of flash, by assigning the reference picture number ref_id as in the example of FIG. 16, it is possible to reduce the amount of code.

In the case of the example of FIG. 15, the motion prediction and compensation process in the inter-template process mode described above with reference to FIG. 14 is performed in the order of the reference frame whose distance in the time axis is close to the target frame, that is, in the ascending order of the reference picture number ref_id. On the other hand, in the case of the example of FIG. 16, although the reference frame is not in the order of the reference frame whose distance in the time axis is close to the target frame, the motion prediction and compensation process is performed in the ascending order of the reference picture number ref_id. That is, in a case where the reference picture number ref_id exists, the motion prediction and compensation process in the inter-template process mode of FIG. 14 is performed in the ascending order of the reference picture number ref_id.

Meanwhile, in the examples of FIGS. 15 and 16, an example of forward prediction is shown. Since the same also applies to backward prediction, the illustration and the description thereof are omitted. Furthermore, the information for identifying the reference frame is not limited to the reference picture number ref_id. However, in the case of a compressed image in which a parameter corresponding to the reference picture number ref_id does not exist, the reference frame is processed in the order of the closeness in the time axis from the target picture for both the forward prediction and the backward prediction.

Furthermore, in the H.264/AVC method, a short term reference picture and a long term reference picture are defined. For example, in a case where a TV (television) conference is considered as a specific application, regarding a background image, a long term reference picture is stored in a memory, and this can be referred to until the decoding process is completed. On the other hand, regarding the motion of a person, the short term reference picture is used in such a manner that, as the decoding process progresses, the short term reference picture that is stored in the memory and is discarded is referred to on a FIFO (First_In_First_Out) basis.

In this case, the motion prediction and compensation process in the inter-template process mode described above with reference to FIG. 14 is applied to only the short term reference picture. On the other hand, in the long term reference picture, the motion prediction and compensation process in the ordinary inter-template process mode, which is similar to the process of step S71 of FIG. 12, is performed. That is, in the case of a long term reference picture, an inter-template motion prediction process is performed in a predetermined search range that is preset in the reference frame.

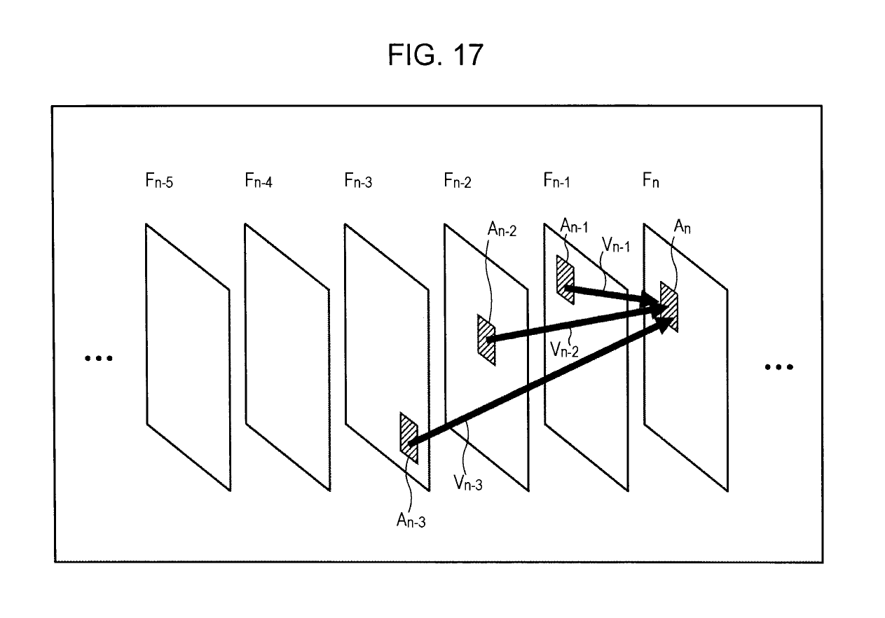

In addition, the motion prediction and compensation process in the inter-template process mode described above with reference to FIG. 14 is also applied to multi-hypothesis motion compensation. A description will be given, with reference to FIG. 17, of multi-hypothesis motion compensation.

In an example of FIG. 17, a target frame Fn to be coded from now, and coded frames Fn-5, . . . Fn-1 are shown. The frame Fn-1 is one frame before the target frame Fn, the frame Fn-2 is two frames before the target frame Fn, and the frame Fn-3 is three frames before the target frame Fn. Furthermore, the frame Fn-4 is four frames before the target frame Fn, and the frame Fn-5 is five frames before the target frame Fn.

For the target frame Fn, a block An is shown. The block An is assumed to be correlated with the block An-1 of the frame Fn-1 one before, and a motion vector Vn-1 is searched for. The block An is assumed to be correlated with the block An-2 of the frame Fn-2 two before, and a motion vector Vn-2 is searched for. The block An is assumed to be correlated with the block An-3 of the frame Fn-3 three before, and a motion vector Vn-3 is searched for.

That is, in the H.264/AVC method, it is defined that a prediction image is generated by using only one reference frame in the case of a P slice and by using only two reference frames in the case of a B slice. In comparison, in multi-hypothesis motion compensation, if Pred is a prediction image, and Ref(id) is a reference image in which the ID of a reference frame is id also with respect to N such that N>3, it is possible to generate a prediction image as in Equation (12).

$$\begin{matrix}[ Math . 9 ] & \\ Pred = \frac{1}{N} {\sum }_{id = 0}^{N - 1} Ref ( id ) & ( 12 )\end{matrix}$$

In a case where the motion prediction and compensation process in the inter-template process mode described above with reference to FIG. 14 is applied to multi-hypothesis motion compensation, a prediction image is generated in accordance with Equation (12) by using the prediction images of the reference frames obtained as in steps S71 to S73 of FIG. 12.

Therefore, in ordinary multi-hypothesis motion compensation, it has been necessary to code the motion vector information for all the reference frames in the compressed image and send the motion vector information to the decoding side. However, in the case of a motion prediction and compensation process in the inter-template process mode, there is no need for that. Thus, the coding efficiency can be improved.

The coded compressed image is transmitted through a predetermined transmission path, and is decoded by an image decoding device. FIG. 18 illustrates the configuration of an embodiment of such an image decoding device.

The image decoding device 101 includes an accumulation buffer 111, a lossless decoding unit 112, a dequantization unit 113, an inverse orthogonal transformation unit 114, a computation unit 115, a deblocking filter 116, a screen rearrangement buffer 117, a D/A conversion unit 118, a frame memory 119, a switch 120, an intra-prediction unit 121, a motion prediction and compensation unit 122, a template motion prediction and compensation unit 123, an MRF search center calculation unit 124, and a switch 125.

The accumulation buffer 111 stores a received compressed image. The lossless decoding unit 112 decodes the information that is coded by the lossless coding unit 66 of FIG. 1, which is supplied from the accumulation buffer 111, in accordance with a method corresponding to the coding method of the lossless coding unit 66. The dequantization unit 113 dequantizes an image that is decoded by the lossless decoding unit 112 in accordance with a method corresponding to the quantization method of the quantization unit 65 of FIG. 1. The inverse orthogonal transformation unit 114 inversely orthogonally transforms the output of the dequantization unit 113 in accordance with a method corresponding to the orthogonal transform method of the orthogonal transformation unit 64 of FIG. 1.

The inversely orthogonally transformed output is added to a prediction image supplied from the switch 125 and decoded by the computation unit 115. The deblocking filter 116 removes block distortion of the decoded image, and thereafter supplies the decoded image to the frame memory 119, whereby it is stored, and is also output to the screen rearrangement buffer 117.

The screen rearrangement buffer 117 performs the rearrangement of images. That is, the order of the frames that are rearranged for the coding order by the screen rearrangement buffer 62 of FIG. 1 is rearranged in the order of the original display. The D/A conversion unit 118 performs D/A conversion on the image supplied from the screen rearrangement buffer 117, and outputs the image to a display (not shown), whereby it is displayed.

The switch 120 reads an image to be inter-processed and an image that is referred to from the frame memory 119, and outputs the images to the motion prediction and compensation unit 122. The switch 120 also reads the image used for intra-prediction from the frame memory 119, and supplies the image to the intra-prediction unit 121.

Information on the intra-prediction mode, which is obtained by decoding the header information, is supplied from the lossless decoding unit 112 to the intra-prediction unit 121. The intra-prediction unit 121 generates a prediction image on the basis of this information, and outputs the generated prediction image to the switch 125.

The information (prediction mode information, motion vector information, and reference frame information) obtained by decoding the header information is supplied from the lossless decoding unit 112 to the motion prediction and compensation unit 122. In a case where information indicating the inter-prediction mode is supplied, the motion prediction and compensation unit 122 performs a motion prediction and compensation process on the image on the basis of the motion vector information and the reference frame information, and generates a prediction image. In a case where information indicating the inter-template prediction mode is supplied, the motion prediction and compensation unit 122 supplies the image to be inter-processed and the image that is referred to, which are read from the frame memory 119, to the template motion prediction and compensation unit 123, whereby a motion prediction and compensation process in the inter-template process mode is performed.

Furthermore, the motion prediction and compensation unit 122 outputs either the prediction image generated in the inter-prediction mode or the prediction image generated in the inter-template process mode to the switch 125 in accordance with the prediction mode information.

On the basis of the image to be inter-processed and the image that is referred to, which are read from the frame memory 119, the template motion prediction and compensation unit 123 performs a motion prediction and compensation process of the inter-template process mode, and generates a prediction image. Meanwhile, the motion prediction and compensation process is basically the same process as the process of the template motion prediction and compensation unit 76 of the image coding device 51.

That is, the template motion prediction and compensation unit 123 performs a motion search of the inter-template process mode in a preset predetermined range with regard to the reference frame, which is closest in the time axis to the target frame, among the plurality of reference frames, performs a compensation process, and generates a prediction image. On the other hand, with regard to those reference frames other than the closest reference frame, the template motion prediction and compensation unit 123 performs a motion search of the inter-template process mode in a predetermined range in the surroundings of the search center that is calculated by the MRF search center calculation unit 124, performs a compensation process, and generates a prediction image.

Therefore, in a case where a motion search for a reference frame other than the reference frame closest in the time axis to the target frame among the plurality of reference frames is performed, the template motion prediction and compensation unit 123 supplies the image to be inter-processed and the image that is referred to, which are read from the frame memory 119, to the MRF search center calculation unit 124. Meanwhile, at this time, the motion vector information found with regard to the reference frame that is one frame before the reference frame for the object of the search in the time axis is also supplied to the MRF search center calculation unit 124.

Furthermore, the template motion prediction and compensation unit 123 determines the prediction image having the minimum prediction error among the prediction images that are generated with regard to the plurality of reference frames to be a prediction image for the target block. Then, the template motion prediction and compensation unit 123 supplies the determined prediction image to the motion prediction and compensation unit 122.

The MRF search center calculation unit 124 calculates the search center of the motion vector in the reference frame for the object of the search by using the motion vector information found with regard to the reference frame that is one frame before the reference frame for the object of the search in the time axis among the plurality of reference frames. Meanwhile, this computation process is basically the same process as the process of the MRF search center calculation unit 77 of the image coding device 51.

The switch 125 selects the prediction image generated by the motion prediction and compensation unit 122 or by the intra-prediction unit 121, and supplies the prediction image to the computation unit 115.

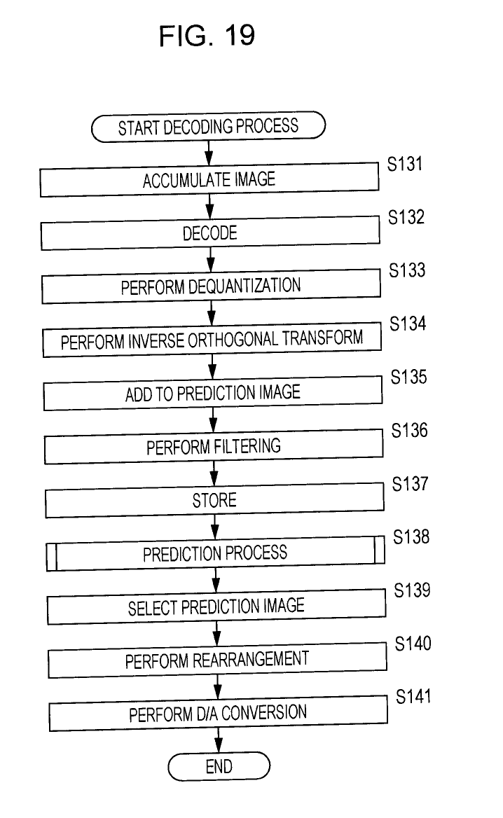

Next, a description will be given, with reference to the flowchart of FIG. 19, of a decoding process performed by the image decoding device 101.

In step S131, the accumulation buffer 111 accumulates the received image. In step S132, the lossless decoding unit 112 decodes the compressed image supplied from the accumulation buffer 111. That is, an I picture, a P picture, and a B picture, which are coded by the lossless coding unit 66 of FIG. 1, are decoded.

At this time, the motion vector information, the reference frame information, the prediction mode information (information indicating an intra-prediction mode, an inter-prediction mode, or an inter-template process mode), and the flag information are also decoded.

That is, in a case where the prediction mode information is an intra-prediction mode information, the prediction mode information is supplied to the intra-prediction unit 121. In a case where the prediction mode information is an inter-prediction mode information, the motion vector information corresponding to the prediction mode information is supplied to the motion prediction and compensation unit 122. In a case where the prediction mode information is an inter-template process mode information, the prediction mode information is supplied to the motion prediction and compensation unit 122.

In step S133, the dequantization unit 113 dequantizes the transform coefficient decoded by the lossless decoding unit 112 on the basis of the characteristics corresponding to the characteristics of the quantization unit 65 of FIG. 1. In step S134, the inverse orthogonal transformation unit 114 inversely orthogonally transforms the transform coefficient dequantized by the dequantization unit 113 on the basis of the characteristics corresponding to the characteristics of the orthogonal transformation unit 64 of FIG. 1. Consequently, the difference information corresponding to the input (the output of the computation unit 63) of the orthogonal transformation unit 64 of FIG. 1 is decoded.

In step S135, the computation unit 115 adds the prediction image that is selected in the process of step S141 (to be described later) and that is input through the switch 125 to the difference information. As a result, the original image is decoded. In step S136, the deblocking filter 116 filters the image output from the computation unit 115. As a result, the block distortion is removed. In step S137, the frame memory 119 stores the filtered image.

In step S138, the intra-prediction unit 121, the motion prediction and compensation unit 122, or the template motion prediction and compensation unit 123 each perform an image prediction process in correspondence with the prediction mode information supplied from the lossless decoding unit 112.

That is, in a case where the intra-prediction mode information is supplied from the lossless decoding unit 112, the intra-prediction unit 121 performs an intra-prediction process of the intra-prediction mode. In a case where the inter-prediction mode information is supplied from the lossless decoding unit 112, the motion prediction and compensation unit 122 performs a motion prediction and compensation process of the inter-prediction mode. Furthermore, in a case where the inter-template process mode information is supplied from the lossless decoding unit 112, the template motion prediction and compensation unit 123 performs a motion prediction and compensation process of the inter-template process mode.

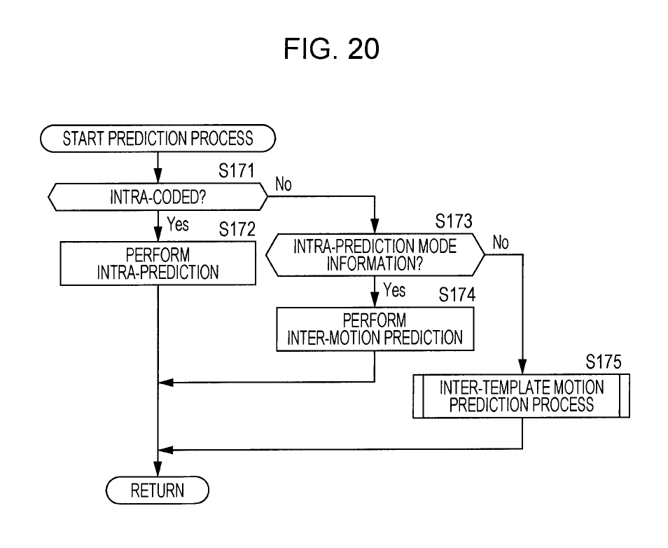

The details of the prediction process in step S138 will be described later with reference to FIG. 20. This process causes the prediction image generated by the intra-prediction unit 121, the prediction image generated by the motion prediction and compensation unit 122, or the prediction image generated by the template motion prediction and compensation unit 123 to be supplied to the switch 125.

In step S139, the switch 125 selects the prediction image. That is, the prediction image generated by the intra-prediction unit 121, the prediction image generated by the motion prediction and compensation unit 122, or the prediction image generated by the template motion prediction and compensation unit 123 is supplied. Thus, the supplied prediction image is selected, is supplied to the computation unit 115, and is added to the output of the inverse orthogonal transformation unit 114 in step S134 in the manner described above.

In step S140, the screen rearrangement buffer 117 performs rearrangement. That is, the order of the frames rearranged for coding by the screen rearrangement buffer 62 of the image coding device 51 is rearranged in the order of the original display.

In step S141, the D/A conversion unit 118 performs D/A conversion on the image from the screen rearrangement buffer 117. This image is output to a display (not shown), whereby the image is displayed.

Next, a description will be given, with reference to the flowchart of FIG. 20, of a prediction process of step S138 of FIG. 19.

In step S171, the intra-prediction unit 121 determines whether or not the target block has been intra-coded. When the intra-prediction mode information is supplied from the lossless decoding unit 112 to the intra-prediction unit 121, in step 171, the intra-prediction unit 121 determines that the target block has been intra-coded, and the process proceeds to step S172.

In step S172, the intra-prediction unit 121 performs intra-prediction. That is, in a case where the image to be processed is an image to be intra-processed, a necessary image is read from the frame memory 119, and is supplied to the intra-prediction unit 121 through the switch 120. In step S172, the intra-prediction unit 121 performs intra-prediction in accordance with the intra-prediction mode information supplied from the lossless decoding unit 112, and generates a prediction image. The generated prediction image is output to the switch 125.

On the other hand, when it is determined in step S171 that the target block has not been intra-coded, the process proceeds to step S173.

In a case where the image to be processed is an image to be inter-processed, the inter-prediction mode information, the reference frame information, and the motion vector information from the lossless decoding unit 112 are supplied to the motion prediction and compensation unit 122. In step S173, the motion prediction and compensation unit 122 determines whether or not the prediction mode information from the lossless decoding unit 112 is inter-prediction mode information. When the motion prediction and compensation unit 122 determines that the prediction mode information is inter-prediction mode information, the motion prediction and compensation unit 122 performs inter-motion prediction in step S174.

In a case where the image to be processed is an image on which an inter-prediction process is to be performed, a necessary image is read from the frame memory 119 and is supplied to the motion prediction and compensation unit 122 through the switch 120. In step S174, the motion prediction and compensation unit 122 performs motion prediction of the inter-prediction mode on the basis of the motion vector supplied from the lossless decoding unit 112, and generates a prediction image.

The generated prediction image is output to the switch 125.

When it is determined in step S173 that the prediction mode information is not inter-prediction mode information, that is, when the prediction mode information is inter-template process mode information, the process proceeds to step S175, whereby an inter-template motion prediction process is performed.

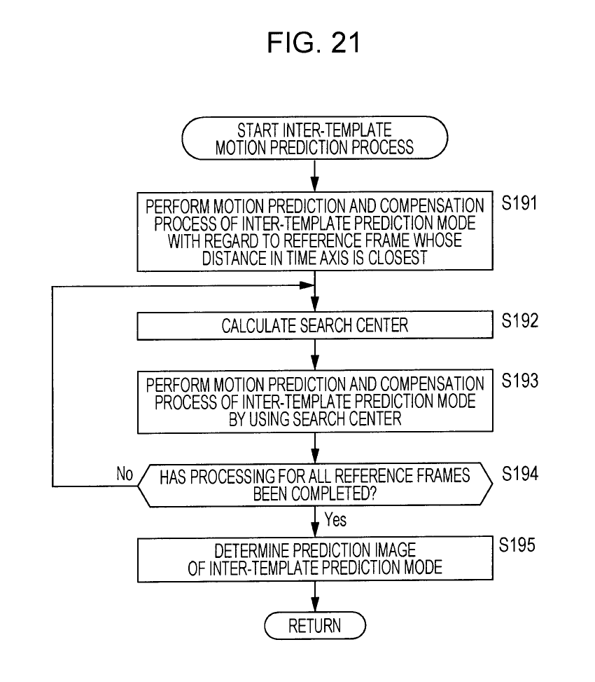

A description will be given, with reference to the flowchart of FIG. 21, of the inter-template motion prediction process of step S175. Meanwhile, for the processes of steps S191 to S195 of FIG. 21, basically the same processes are performed as the processes of steps S71 to S75 of FIG. 12. Accordingly, the repeated description of the details thereof is omitted.

In a case where the image to be processed is an image on which the inter-template process is to be performed, a necessary image is read from the frame memory 119 and is supplied to the template motion prediction and compensation unit 123 through the switch 120 and the motion prediction and compensation unit 122.

In step S191, the template motion prediction and compensation unit 123 performs a motion prediction and compensation process of the inter-template process mode with regard to a reference frame whose distance in the time axis to the target frame is closest. That is, the template motion prediction and compensation unit 123 searches for the motion vector in accordance with the inter-template matching method with regard to the reference frame whose distance in the time axis to the target frame is closest. Then, the template motion prediction and compensation unit 123 performs a motion prediction and compensation process on the reference image on the basis of the found motion vector, and generates a prediction image.

In step S192, in order to perform a motion search with regard to the reference frame other than the reference frame that is closest in the time axis to the target frame among the plurality of reference frames, the template motion prediction and compensation unit 123 causes the MRF search center calculation unit 124 to calculate the search center of the reference frame. Then, in step S193, the template motion prediction and compensation unit 123 performs a motion search in a predetermined range in the surroundings of the search center calculated by the MRF search center calculation unit 124, performs a compensation process, and generates a prediction image.

In step S194, the template motion prediction and compensation unit 123 determines whether or not the processing for all the reference frames has been completed. When it is determined in step S194 that the processing has not yet been completed, the process returns to step S192, and the processing at and subsequent to step S192 is repeated.

When it is determined in step S194 that the processing for all the reference frames has been completed, the process proceeds to step S195. In step S195, the template motion prediction and compensation unit 123 determines the prediction image of the inter-template mode for the target block from the prediction images with respect to all the reference frames that are obtained in the process of step S191 or S193.

That is, the prediction image having the minimum prediction error that is obtained by using an SAD (Sum of Absolute Difference) among the prediction images for all the reference frames is determined to be the prediction image for the target block, and the determined prediction image is supplied to the switch 125 through the motion prediction and compensation unit 122.

As in the foregoing, both the image coding device and the image decoding device perform motion prediction based on template matching, making it possible to display good image quality without sending motion vector information, reference frame information, and the like.

In addition, when performing a motion prediction and compensation process in the inter-template process mode of the multi-reference frame, the motion vector information obtained in the reference frame that is one frame before in the time axis is used to obtain the search center in the next reference frame, and a motion search is performed by using the search center. Consequently, it is possible to suppress an increase in the number of computations while minimizing a decrease in the coding efficiency.

Furthermore, when performing a motion prediction and compensation process in accordance with the H.264/AVC method, a prediction based on template matching is also performed, a coding process is performed by selecting a better cost function value. Thus, it is possible to improve the coding efficiency.

Meanwhile, in the above-described description, a case in which the size of a macroblock is of 16×16 pixels has been described. The present invention can be applied to an extended macroblock size, which is described in “Video Coding Using Extended Block Sizes”, VCEG-AD09, ITU-Telecommunications Standardization Sector STUDY GROUP Question 16—Contribution 123, January 2009.

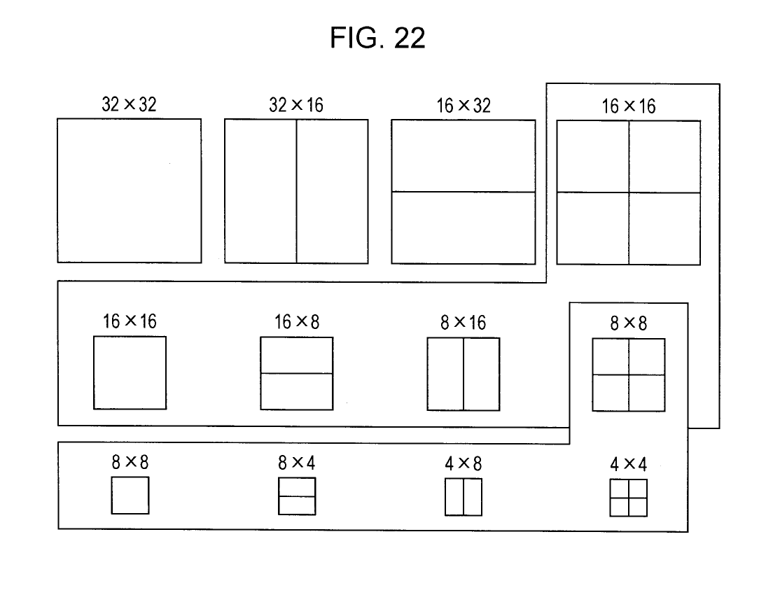

FIG. 22 illustrates an example of an extended macroblock size. In the above-described description, the macroblock size has been extended to 32×32 pixels.

In the upper stage of FIG. 22, macroblocks composed of 32×32 pixels, which are divided into blocks (partitions) of 32×32 pixels, 32×16 pixels, 16×32 pixels, and 16×16 pixels, are shown in sequence from the left. In the middle stage of FIG. 22, macroblocks composed of 16×16 pixels, which are divided into blocks (partitions) of 16×16 pixels, 16×8 pixels, 8×16 pixels, and 8×8 pixels, are shown in sequence from the left. Furthermore, in the lower stage of FIG. 22, blocks of 8×8 pixels, which are divided into blocks of 8×8 pixels, 8×4 pixels, 4×8 pixels, and 4×4 pixels, are shown in sequence from the left.

That is, the macroblock of 32×32 pixels can be processed in units of blocks of 32×32 pixels, 32×16 pixels, 16×32 pixels, and 16×16 pixels, which are shown in the upper stage of FIG. 22.

Furthermore, for the block of 16×16 pixels shown on the right side of the upper stage, processing of blocks of 16×16 pixels, 16×8 pixels, 8×16 pixels, and 8×8 pixels, which are shown in the middle stage, is possible similarly to the H.264/AVC method.

In addition, for the block of 8×8 pixels shown on the right side, processing of blocks of 8×8 pixels, 8×4 pixels, 4×8 pixels, and 4×4 pixels, which are shown in the lower stage, is possible similarly to the H.264/AVC method.

As a result of adopting such a hierarchical structure, in the extended macroblock size, a larger block is defined as a super-set thereof while maintaining compatibility with the H.264/AVC method regarding the blocks of 16×16 pixels or smaller.

The present invention can also be applied to an extended macroblock size, which is proposed as described above.

In the foregoing, although the H.264/AVC method has been used as a coding method, other coding method/decoding methods can also be used.

Meanwhile, the present invention can be applied to an image coding device and an image decoding device that are used when image information (bit stream) that is compressed by an orthogonal transform such as a discrete cosine transform, and motion compensation is to be received through a network medium, such as a satellite broadcast, a cable TV (television), the Internet, a mobile phone, and the like, or when the image information is to be processed on a storage medium, such as optical and magnetic discs, and a flash memory as in, for example, MPEG, H.26x, or the like. Furthermore, the present invention can also be applied to a motion prediction and compensation device included in an image coding device and an image decoding device.

The above-described series of processing can be performed by hardware and can also be performed by software. When the series of processing is to be performed by software, a program forming the software is installed from a program recording medium into, for example, a general-purpose personal computer incorporated in dedicated hardware or into a computer capable of performing various functions by installing various programs.

A program recording medium for storing a program that is installed into a computer and is made to be an executable state by the computer is formed of a removable medium that is a packaged medium, which is formed of a magnetic disc (including a flexible disc), an optical disc (including CD-ROM (Compact Disc-Read Only Memory), a DVD (Digital Versatile Disc), or a magneto-optical disc), a semiconductor memory, or the like, a ROM, a hard-disk or the like, in which the program is temporarily or permanently stored. The storage of the program on the program recording medium is performed by using a wired or wireless communication medium, such as a local area network, the Internet, and a digital satellite broadcast through an interface, such as a router, a modem and the like, as necessary.

Meanwhile, in this specification, steps describing a program recorded on a recording medium include processes that are performed in a time-series manner according to the written order, but also processes that are performed in parallel or individually although they may not be performed in a time-series manner.

Furthermore, the embodiment of the present invention is not limited to the above-mentioned embodiment, and various changes are possible in a range without deviating from the spirit and scope of the present invention.

For example, the above-mentioned image coding device 51 and image decoding device 101 can be applied to any electronic apparatus. An example thereof will be described below.

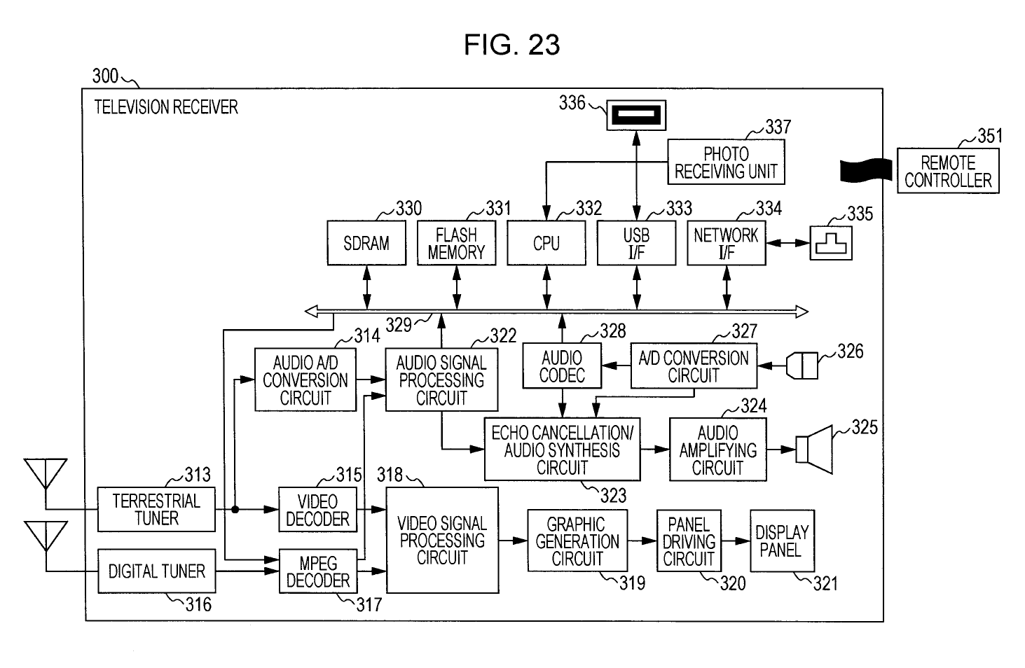

FIG. 23 is a block diagram illustrating an example of the main configuration of a television receiver using an image decoding device to which the present invention is applied.

A television receiver 300 shown in FIG. 23 includes a terrestrial tuner 313, a video decoder 315, a video signal processing circuit 318, a graphic generation circuit 319, a panel driving circuit 320, and a display panel 321.

The terrestrial tuner 313 receives a broadcast signal of a terrestrial analog broadcast through an antenna, demodulates the broadcast signal, obtains a video signal, and supplies it to the video decoder 315. The video decoder 315 performs a decoding process on the video signal supplied from the terrestrial tuner 313, and supplies the obtained digital component signal to the video signal processing circuit 318.

The video signal processing circuit 318 performs a predetermined process, such as noise reduction, on the video data supplied from the video decoder 315, and supplies the obtained video data to the graphic generation circuit 319.

The graphic generation circuit 319 generates video data of a program to be displayed on the display panel 321, image data by processing based on an application that is supplied through a network, and supplies the generated video data and image data to the panel driving circuit 320. Furthermore, the graphic generation circuit 319 also performs, as appropriate, a process in which video data (graphic) for displaying a screen used by a user to select an item or the like is generated, and video data obtained by superposing the video data (graphic) onto the video data of a program is supplied to the panel driving circuit 320.

The panel driving circuit 320 drives the display panel 321 on the basis of the data supplied from the graphic generation circuit 319, thereby displaying the video of the program and the above-mentioned various screens on the display panel 321.

The display panel 321 is formed of an LCD (Liquid Crystal Display) or the like, and displays the video of the program, and the like under the control of the panel driving circuit 320.

Furthermore, the television receiver 300 also includes an audio A/D (Analog/Digital) conversion circuit 314, an audio signal processing circuit 322, an echo cancellation/audio synthesis circuit 323, an audio amplification circuit 324, and a speaker 325.

The terrestrial tuner 313 obtains not only a video signal but also an audio signal by demodulating a received broadcast signal. The terrestrial tuner 313 supplies the obtained audio signal to the audio A/D conversion circuit 314.

The audio A/D conversion circuit 314 performs an A/D conversion process on the audio signal supplied from the terrestrial tuner 313, and supplies the obtained digital audio signal to the audio signal processing circuit 322.

The audio signal processing circuit 322 performs a predetermined process, such as noise reduction, on the audio data supplied from the audio A/D conversion circuit 314, and supplies the obtained audio data to the echo cancellation/audio synthesis circuit 323.

The echo cancellation/audio synthesis circuit 323 supplies the audio data supplied from the audio signal processing circuit 322 to the audio amplification circuit 324.

The audio amplification circuit 324 performs a D/A conversion process and an amplification process on the audio data supplied from the echo cancellation/audio synthesis circuit 323, adjusts the audio data to a predetermined sound volume, and thereafter outputs audio from the speaker 325.

In addition, the television receiver 300 includes a digital tuner 316 and an MPEG decoder 317.

The digital tuner 316 receives a broadcast signal of a digital broadcast (terrestrial digital broadcast, BS (Broadcasting Satellite)/CS (Communications Satellite) digital broadcast) through an antenna, demodulates the broadcast signal, and obtains an MPEG-TS (Moving Picture Experts Group-Transport Stream), and supplies it to the MPEG decoder 317.

The MPEG decoder 317 releases the scramble performed on the MPEG-TS supplied from the digital tuner 316 so as to extract a stream containing the data of the program to be reproduced (to be viewed). The MPEG decoder 317 decodes the audio packets forming the extracted stream, supplies the obtained audio data to the audio signal processing circuit 322, and decodes the video packets forming the stream, and supplies the obtained video data to the video signal processing circuit 318. Furthermore, the MPEG decoder 317 supplies the EPG (Electronic Program Guide) data extracted from the MPEG-TS to the CPU 332 through a path (not shown).

The television receiver 300 uses the above-mentioned image decoding device 101 as the MPEG decoder 317 for decoding video packets in this manner. Therefore, similarly to the case of the image decoding device 101, when a motion prediction and compensation process in the inter-template process mode of the multi-reference frame is to be performed, the MPEG decoder 317 uses the motion vector information obtained in the reference frame that is one frame before in the time axis so as to obtain the search center in the next reference frame, and performs a motion search by using the search center. As a result, it is possible to realize the reduction in the number of computations while minimizing a decrease in the coding efficiency.

Similarly to the video data supplied from the video decoder 315, the video data supplied from the MPEG decoder 317 is subjected to a predetermined process in the video signal processing circuit 318. Then, the video data that is generated in the graphic generation circuit 319, and the like are superposed as appropriate on the video data on which a predetermined process has been performed. The video data is supplied through the panel driving circuit 320 to the display panel 321, whereby the image is displayed.

Similarly to the case of the audio data supplied from the audio A/D conversion circuit 314, the audio data supplied from the MPEG decoder 317 is subjected to a predetermined process in the audio signal processing circuit 322. Then, the audio data on which the predetermined process has been performed is supplied through the echo cancellation/audio synthesis circuit 323 to the audio amplification circuit 324, whereby a D/A conversion process and an amplification process are performed. As a result, the audio that has been adjusted to a predetermined sound volume is output from the speaker 325.

Furthermore, the television receiver 300 includes a microphone 326 and an A/D conversion circuit 327.

The A/D conversion circuit 327 receives an audio signal of the user, which is collected by the microphone 326 provided for voice conversation in the television receiver 300. The A/D conversion circuit 327 performs an A/D conversion process on the received audio signal, and supplies the obtained digital audio data to the echo cancellation/audio synthesis circuit 323.

In a case where the audio data of the user (user A) of the television receiver 300 has been supplied from the A/D conversion circuit 327, the echo cancellation/audio synthesis circuit 323 performs echo cancellation by targeting the audio data of the user A. Then, after the echo cancellation, the echo cancellation/audio synthesis circuit 323 causes audio data obtained by combining with other audio data to be output from the speaker 325 through the audio amplification circuit 324.

In addition, the television receiver 300 includes an audio codec 328, an internal bus 329, an SDRAM (Synchronous Dynamic Random Access Memory) 330, a flash memory 331, a CPU 332, a USB (Universal Serial Bus) I/F 333, and a network I/F 334.

The A/D conversion circuit 327 receives the audio signal of the user, which is collected by the microphone 326 provided for voice conversation in the television receiver 300. The A/D conversion circuit 327 performs an A/D conversion process on the received audio signal, and supplies the obtained digital audio data to the audio codec 328.

The audio codec 328 converts the audio data supplied from the A/D conversion circuit 327 into data of a predetermined format, which is transmitted through a network, and supplies the data to the network I/F 334 through an internal bus 329.

The network I/F 334 is connected to the network through a cable mounted to a network terminal 335. The network I/F 334 transmits, for example, the audio data supplied from the audio codec 328 to another device connected to the network. Furthermore, the network I/F 334 receives, through the network terminal 335, for example, the audio data transmitted from another device connected through the network, and supplies the audio data to the audio codec 328 through the internal bus 329.

The audio codec 328 converts the audio data supplied from the network I/F 334 into data of a predetermined format, and supplies the data to the echo cancellation/audio synthesis circuit 323.

The echo cancellation/audio synthesis circuit 323 performs echo cancellation by targeting the audio data supplied from the audio codec 328, and causes audio data obtained by combining with other audio data to be output from the speaker 325 through the audio amplification circuit 324.

The SDRAM 330 stores various data necessary for the CPU 332 to perform processing.

The flash memory 331 stores a program executed by the CPU 332. The program stored in the flash memory 331 is read by the CPU 332 at a predetermined time, such as the start-up time of the television receiver 300. In the flash memory 331, EPG data obtained through a digital broadcast, data obtained from a server through a network, and the like are stored.

For example, in the flash memory 331, an MPEG-TS containing content data that is obtained from a predetermined server through a network under the control of the CPU 332 is stored. The flash memory 331 supplies the MPEG-TS to the MPEG decoder 317 through the internal bus 329, for example, under the control of the CPU 332.

The MPEG decoder 317 processes the MPEG-TS in a manner similar to the case of the MPEG-TS supplied from the digital tuner 316. As described above, it is possible for the television receiver 300 to receive content data formed of video, audio, and the like through a network, to decode the content data by using the MPEG decoder 317, to display the video, and to output audio.

Furthermore, the television receiver 300 includes a photoreceiving unit 337 for receiving an infrared signal transmitted from the remote controller 351.

The photoreceiving unit 337 receives the infrared from the remote controller 351, and outputs a control code indicating the content of the user operation obtained by demodulation to the CPU 332.

The CPU 332 executes the program stored in the flash memory 331, and controls the entire operation of the television receiver 300 in accordance with the control code supplied from the photoreceiving unit 337. The CPU 332 and the units of the television receiver 300 are connected with one another through a path (not shown).

The USB I/F 333 performs transmission and reception of data to and from apparatuses outside the television receiver 300, which are connected through a USE cable mounted to the USB terminal 336. The network I/F 334 is connected to the network through a cable mounted to the network terminal 335, and also performs transmission and reception of data other than audio data to and from various apparatuses that are connected to the network.

The television receiver 300 uses the image decoding device 101 as the MPEG decoder 317, making it possible to realize the reduction in the number of computations while minimizing a decrease in the coding efficiency. As a result, it is possible for the television receiver 300 to obtain a decoded image with high accuracy at high speed from the broadcast signal received through the antenna and content data obtained through the network, and to display the decoded image.

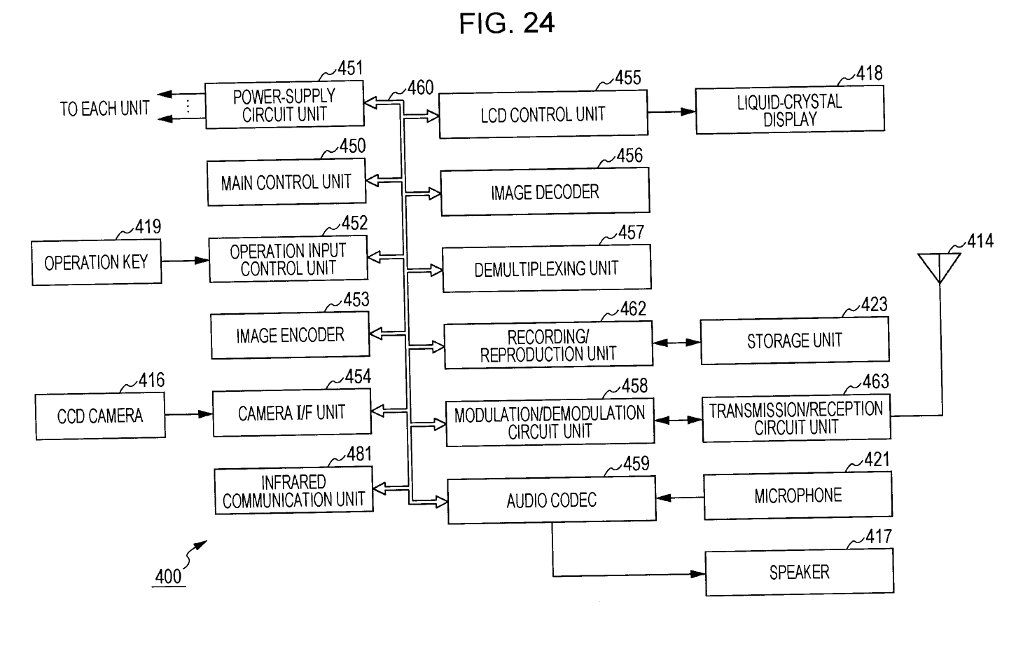

FIG. 24 is a block diagram illustrating an example of the main configuration of a mobile phone that uses an image coding device and an image decoding device to which the present invention is applied.

A mobile phone 400 shown in FIG. 24 includes a main control unit 450 configured to centrally control each unit, a power-supply circuit unit 451, an operation input control unit 452, an image encoder 453, a camera I/F unit 454, an LCD control unit 455, an image decoder 456, a demultiplexing unit 457, a recording/reproduction unit 462, a modulation/demodulation circuit unit 458, and an audio codec 459. These are connected to one another through a bus 460.

Furthermore, the mobile phone 400 includes an operation key 419, a CCD (Charge Coupled Devices) camera 416, a liquid-crystal display 418, a storage unit 423, a transmission and reception circuit unit 463, an antenna 414, a microphone 421, and a speaker 417.

When a call-ending and power-supply key is turned on through the operation of the user, the power-supply circuit unit 451 supplies electric power to each unit from a battery pack, thereby causing the mobile phone 400 to be started up in an operable state.

Under the control of the main control unit 450 formed of a CPU, a ROM, a RAM, and the like, the mobile phone 400 performs various operations, such as transmission and reception of an audio signal, transmission and reception of electronic mail and image data, image capturing, and data recording, in various modes, such as a voice conversation mode or a data communication mode.

For example, in the voice conversation mode, the mobile phone 400 converts the audio signal collected by a microphone 421 into digital audio data by using the audio codec 459, performs a spread spectrum process thereon by using the modulation/demodulation circuit unit 458, and performs a digital-to-analog conversion process and a frequency conversion process by using the transmission and reception circuit unit 463. The mobile phone 400 transmits the transmission signal obtained by the conversion process to a base station (not shown) through the antenna 414. The transmission signal (audio signal) transmitted to the base station is supplied to the mobile phone of the telephone call party through the public telephone network.

Furthermore, for example, in the voice conversation mode, the mobile phone 400 amplifies the reception signal received by the antenna 414 by using the transmission and reception circuit unit 463, further performs a frequency conversion process and an analog-to-digital conversion process, performs a spectrum despreading process by using the modulation/demodulation circuit unit 458, and converts the reception signal into an analog audio signal by using the audio codec 459. The mobile phone 400 outputs the analog audio signal obtained by conversion from the speaker 417.

In addition, for example, in a case where electronic mail is to be transmitted in the data communication mode, the mobile phone 400 accepts the text data of the electronic mail, which is input by the operation of the operation key 419 in the operation input control unit 452. The mobile phone 400 processes the text data in the main control unit 450, and causes the liquid-crystal display 418 to display the text data as an image through the LCD control unit 455.

Furthermore, in the mobile phone 400, electronic mail data is generated on the basis of the text data, user instructions, and the like that are received by the operation input control unit 452 in the main control unit 450. The mobile phone 400 performs a spread spectrum process on the electronic mail data by using the modulation/demodulation circuit unit 458, and performs a digital-to-analog conversion process and a frequency conversion process thereon by using the transmission and reception circuit unit 463. The mobile phone 400 transmits the transmission signal obtained by the conversion process to a base station (not shown) through the antenna 414. The transmission signal (electronic mail) transmitted to the base station is supplied to a predetermined destination through a network, a mail server, and the like.

Furthermore, for example, in a case where electronic mail is to be received in the data communication mode, the mobile phone 400 receives the signal transmitted from the base station through the antenna 414 by using the transmission and reception circuit unit 463, amplifies the signal, and further performs a frequency conversion process and an analog digital conversion process thereon. The mobile phone 400 performs a spectrum despreading process on the reception signal by using the modulation/demodulation circuit unit 458 so as to restore the original electronic mail data. The mobile phone 400 displays the restored electronic mail data on the liquid-crystal display 418 through the LCD control unit 455.

Meanwhile, it is also possible for the mobile phone 400 to record (store) the received electronic mail data in the storage unit 423 through the recording/reproduction unit 462.

This storage unit 423 is an arbitrary rewritable storage medium. The storage unit 423 may be, for example, a semiconductor memory, such as a RAM or a built-in flash memory, may be a hard-disk, or may be a removable medium, such as a magnetic disc, a magneto-optical disc, an optical disc, a USB memory, or a memory card. Of course, the storage unit 423 may be other than these.

In addition, for example, in a case where image data is to be transmitted in the data communication mode, the mobile phone 400 generates image data by performing image capture using the CCD camera 416. The CCD camera 416 has optical devices, such as a lens and an aperture, and CCDs serving as photoelectric conversion elements, captures an image of a subject, converts the strength of the received light into an electrical signal, and generates the image data of the image of the subject. The image encoder 453 compresses and codes the image data through the camera I/F unit 454 in accordance with a predetermined coding method, such as, for example, MPEG2 or MPEG4, thereby converting the image data into coded image data.

The mobile phone 400 uses the above-mentioned image coding device 51 as the image encoder 453 for performing such a process. Therefore, similarly to the case of the image coding device 51, when a motion prediction and compensation process in the inter-template process mode of the multi-reference frame is to be performed, the image encoder 453 obtains the search center in the next reference frame by using the motion vector information obtained in the reference frame in the time axis, and performs a motion search by using the search center. As a result, it is possible to realize the reduction in the number of computations while minimizing a decrease in the coding efficiency.

Meanwhile, at this time, the mobile phone 400 concurrently causes the audio codec 459 to perform analog-to-digital conversion on the audio collected by the microphone 421 while performing image capture using the CCD camera 416, and further code the audio.

In the mobile phone 400, the demultiplexing unit 457 multiplexes the coded image data supplied from the image encoder 453 with the digital audio data supplied from the audio codec 459 in accordance with a predetermined method. In the mobile phone 400, the modulation/demodulation circuit unit 458 performs a spread spectrum process on the multiplexed data obtained thereby, and the transmission and reception circuit unit 463 performs a digital-to-analog conversion process and a frequency conversion process thereon. The mobile phone 400 transmits the transmission signal obtained by the conversion process to the base station (not shown) through the antenna 414. The transmission signal (image data) transmitted to the base station is supplied to the communication party through a network or the like.

Meanwhile, in a case where the image data is not transmitted, the mobile phone 400 can cause the image data generated by the CCD camera 416 to be displayed on the liquid-crystal display 418 through the LCD control unit 455 without the intervention of the image encoder 453.

Furthermore, for example, in the data communication mode, in a case where the data of a moving image file linked to a simplified home page or the like is to be received, the mobile phone 400 uses the transmission and reception circuit unit 463 to receive the signal transmitted from the base station through the antenna 414, amplify the signal, and perform a frequency conversion process and an analog-to-digital conversion process thereon. The mobile phone 400 uses the modulation/demodulation circuit unit 458 to perform a spectrum despreading process on the reception signal and restores the original multiplexed data. The mobile phone 400 uses the demultiplexing unit 457 to demultiplex the multiplexed data into coded image data and audio data.

The mobile phone 400 uses the image decoder 456 so as to decode the coded image data in accordance with a decoding method corresponding to a predetermined coding method, such as MPEG2 or MPEG4, thereby generating reproduced movie data, and causes this data to be displayed on the liquid-crystal display 418 through the LCD control unit 455. As a result, for example, the moving image data contained in the moving image file linked to the simplified home page is displayed on the liquid-crystal display 418.

The mobile phone 400 uses the above-mentioned image decoding device 101 as the image decoder 456 for performing such a process. Therefore, similarly to the case of the image decoding device 101, when a motion prediction and compensation process in the inter-template process mode of the multi-reference frame is to be performed, the image decoder 456 obtains the search center in the next reference frame by using the motion vector information obtained in the reference frame that is one frame before in the time axis, and performs a motion search by using the search center. As a result, it is possible to realize the reduction in the number of computations while minimizing a decrease in the coding efficiency.

At this time, the mobile phone 400 concurrently uses the audio codec 459 to convert the digital audio data into an analog audio signal and cause this signal to be output from the speaker 417. As a result, for example, the audio data contained in the moving image file linked into the simplified home page is reproduced.

Meanwhile, similarly to the case of electronic mail, it is also possible for the mobile phone 400 to cause the received data linked to the simplified home page or the like to be recorded (stored) in the storage unit 423 through the recording/reproduction unit 462.

Furthermore, the mobile phone 400 can use the main control unit 450 so as to analyze two-dimensional codes that are captured and obtained by the CCD camera 416 and obtain the information recorded in the two-dimensional codes.

In addition, the mobile phone 400 can use an infrared communication unit 481 so as to communicate with external apparatuses using infrared.

The mobile phone 400 can use the image coding device 51 as the image encoder 453 so as to realize speed-up of processing, and also improve the coding efficiency of coded data that is generated by coding the image data generated in, for example, the CCD camera 416. As a result, it is possible for the mobile phone 400 to provide coded data (image data) having high coding efficiency to another device.

Furthermore, the mobile phone 400 can use the image decoding device 101 as the image decoder 456 so as to realize speed-up of processing, and generate a prediction image having high accuracy. As a result, it is possible for the mobile phone 400 to, for example, obtain a decoded image having high precision from the moving image file linked to the simplified home page and display the decoded image.

Meanwhile, in the foregoing, it has been described that the mobile phone 400 uses the CCD camera 416. Alternatively, an image sensor (CMOS image sensor) using a CMOS (Complementary Metal Oxide Semiconductor) in place of the CCD camera 416 may be used. In this case, also, similarly to using the CCD camera 416, it is possible for the mobile phone 400 to capture an image of a subject and generate the image data of the image of the subject.

Furthermore, in the foregoing, a description has been given of the mobile phone 400. For example, as long as the apparatus has an image-capturing function and a communication function similar to those of the mobile phone 400, such as a PDA (Personal Digital Assistants), a smartphone, a UMPC (Ultra Mobile Personal Computer), a network book, or a notebook personal computer, it is possible to apply the image coding device 51 and the image decoding device 101 in a manner similar to the case of the mobile phone 400.

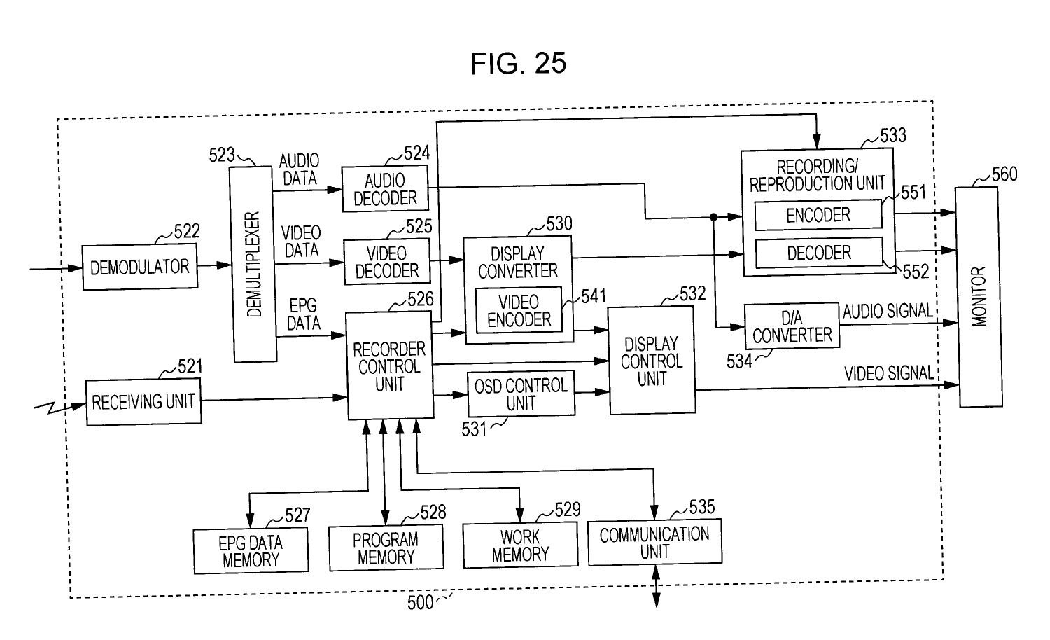

FIG. 25 is a block diagram illustrating an example of the main configuration of a hard-disk recorder using an image coding device and an image decoding device to which the present invention is applied.

A hard-disk recorder (HDD recorder) 500 shown in FIG. 25 is a device that stores, in a built-in hard-disk, audio data and video data of a broadcast program, which are contained in the broadcast signal (television signal) transmitted from a satellite, an antenna, and the like, the audio data and the video data being received by a tuner, and that provides the stored data to the user at a time in accordance with the instruction of the user.

The hard-disk recorder 500, for example, extracts the audio data and the video data from the broadcast signal, decodes the audio data and the video data as appropriate, and causes them to be stored in the built-in hard-disk. Furthermore, it is also possible for the hard-disk recorder 500 to, for example, obtain audio data and video data from another device through a network, decode the audio data and the video data as appropriate, and causes them to be stored in the built-in hard-disk.

In addition, the hard-disk recorder 500, for example, decodes the audio data and the video data that are recorded in the built-in hard-disk, supplies them to a monitor 560, and causes the image to be displayed on the screen of the monitor 560. Furthermore, it is possible for the hard-disk recorder 500 to cause the audio thereof to be output from the speaker of the monitor 560.

The hard-disk recorder 500, for example, decodes the audio data and the video data that are extracted from the broadcast signal obtained through a tuner or the audio data and the video data obtained from another device through a network, supplies them to the monitor 560, and causes the image thereof to be displayed on the screen of the monitor 560. Furthermore, it is also possible for the hard-disk recorder 500 to output the audio thereof from the speaker of the monitor 560.

Of course, the other operations are also possible.

As shown in FIG. 25, the hard-disk recorder 500 includes a receiving unit 521, a demodulator 522, a demultiplexer 523, an audio decoder 524, a video decoder 525, and a recorder control unit 526. The hard-disk recorder 500 further includes an EPG data memory 527, a program memory 528, a work memory 529, a display converter 530, an OSD (On-screen Display) control unit 531, a display control unit 532, a recording/reproduction unit 533, a D/A converter 534, and a communication unit 535.

Furthermore, the display converter 530 includes a video encoder 541. The recording/reproduction unit 533 includes an encoder 551 and a decoder 552.

The receiving unit 521 receives an infrared signal from a remote controller (not shown), converts the infrared signal into an electrical signal, and outputs the electrical signal to the recorder control unit 526. The recorder control unit 526 is constituted by, for example, a micro-processor, and performs various processing in accordance with programs stored in the program memory 528. At this time, the recorder control unit 526 uses the work memory 529 as necessary.

The communication unit 535 is connected to a network, and performs a communication process with other devices through the network. For example, the communication unit 535 is controlled by the recorder control unit 526, communicates with a tuner (not shown), and outputs a station selection control signal to the tuner mainly.

The demodulator 522 demodulates the signal supplied from the tuner and outputs the signal to the demultiplexer 523. The demultiplexer 523 demultiplexes the data supplied from the demodulator 522 into audio data, video data, and EPG data, and outputs them to the audio decoder 524, the video decoder 525, and the recorder control unit 526, respectively.

The audio decoder 524 decodes the input audio data in accordance with, for example, the MPEG method, and outputs the audio data to the recording/reproduction unit 533. The video decoder 525 decodes the input video data in accordance with, for example, the MPEG method, and outputs the video data to the display converter 530. The recorder control unit 526 supplies the input EPG data to the EPG data memory 527, whereby it is stored.

The display converter 530 encodes the video data supplied from the video decoder 525 or the recorder control unit 526 to video data of, for example, the NTSC (National Television Standards Committee) method by using the video encoder 541, and outputs the video data to the recording/reproduction unit 533. Furthermore, the display converter 530 converts the size of the screen of the video data supplied from the video decoder 525 or the recorder control unit 526 into a size corresponding to the size of the monitor 560. The display converter 530 further converts the video data, in which the size of the screen has been converted, into video data of the NTSC method by using the video encoder 541, converts the video data into an analog signal, and outputs it to the display control unit 532.

Under the control of the recorder control unit 526, the display control unit 532 superposes the OSD signal output by the OSD (On-screen Display) control unit 531 onto the video signal that is input from the display converter 530, outputs the signal to the display of the monitor 560, whereby it is displayed.

Furthermore, the audio data that is output by the audio decoder 524, which has been converted into an analog signal by the D/A converter 534, is also supplied to the monitor 560. The monitor 560 outputs this audio signal from the built-in speaker.

The recording/reproduction unit 533 has a hard-disk as a storage medium for recording video data, audio data, and the like.

The recording/reproduction unit 533 encodes, for example, the audio data supplied from the audio decoder 524 in accordance with the MPEG method by using the encoder 551. Furthermore, the recording/reproduction unit 533 encodes the video data supplied from the video encoder 541 of the display converter 530 in accordance with the MPEG method by using the encoder 551. The recording/reproduction unit 533 combines the coded data of the audio data and the coded data of the video data by using a multiplexer. The recording/reproduction unit 533 performs channel coding on the combined data, amplifies the data, and writes the data in the hard-disk through a recording head.

The recording/reproduction unit 533 reproduces the data recorded in the hard-disk through a reproduction head, amplifies the data, and demultiplexes the data into audio data and video data by using a demultiplexer. The recording/reproduction unit 533 decodes the audio data and the video data in accordance with the MPEG method by using the decoder 552. The recording/reproduction unit 533 performs D/A conversion on the decoded audio data, and outputs the audio data to the speaker of the monitor 560. Furthermore, the recording/reproduction unit 533 performs D/A conversion on the decoded video data, and outputs the video data to the display of the monitor 560.

The recorder control unit 526 reads the up-to-date EPG data from the EPG data memory 527 in accordance with the user instructions indicated by the infrared signal from the remote controller, the infrared signal being received through the receiving unit 521, and supplies the EPG data to the OSD control unit 531. The OSD control unit 531 generates image data corresponding to the input EPG data, and outputs the image data to the display control unit 532. The display control unit 532 outputs the video data input from the OSD control unit 531 to the display of the monitor 560, whereby the video data is displayed. As a result, an EPG (electronic program guide) is displayed on the display of the monitor 560.

Furthermore, it is possible for the hard-disk recorder 500 to obtain various data, such as video data, audio data, and EPG data, which are supplied from another device through a network, such as the Internet.

The communication unit 535 is controlled by the recorder control unit 526, obtains coded data, such as video data, audio data, EPG data, and the like, which are transmitted from another device through a network, and supplies the coded data to the recorder control unit 526. The recorder control unit 526, for example, supplies the obtained coded data of the video data and the audio data to the recording/reproduction unit 533, whereby it is stored in the hard-disk. At this time, the recorder control unit 526 and the recording/reproduction unit 533 may perform processing, such as re-encoding, as necessary.

Furthermore, the recorder control unit 526 decodes the coded data of the obtained video data and audio data, and supplies the obtained video data to the display converter 530. Similarly to that for the video data supplied from the video decoder 525, the display converter 530 processes the video data supplied from the recorder control unit 526, supplies the video data through the display control unit 532 to the monitor 560, whereby the image thereof is displayed.

Furthermore, in response to this image display, the recorder control unit 526 may supply the decoded audio data to the monitor 560 through the D/A converter 534, and cause the audio thereof to be output from the speaker.

In addition, the recorder control unit 526 decodes the coded data of the obtained EPG data, and supplies the decoded EPG data to the EPG data memory 527.

The hard-disk recorder 500 such as that above uses the image decoding device 101 as a decoder that is incorporated in each of the video decoder 525, the decoder 552, and the recorder control unit 526. Therefore, similarly to the case of the image decoding device 101, when a motion prediction and compensation process in the inter-template process mode of the multi-reference frame is to be performed, the decoders incorporated in the video decoder 525, the decoder 552, the recorder control unit 526 obtain the search center in the next reference frame by using the motion vector information obtained in the reference frame that is one frame before in the time axis, and performs a motion search by using the search center. As a result, it is possible to realize the reduction in the number of computations while minimizing a decrease in the coding efficiency.

Therefore, it is possible for the hard-disk recorder 500 to realize speed-up of processing and also generate a prediction image having high accuracy. As a result, the hard-disk recorder 500 can obtain, for example, a higher-precision decoded image from the coded data of the video data received through a tuner, the coded data of the video data read from the hard-disk of the recording/reproduction unit 533, and the coded data of the video data obtained through the network, and causes the video data to be displayed on the monitor 560.

Furthermore, the hard-disk recorder 500 uses the image coding device 51 as the encoder 551. Therefore, similarly to the case of the image coding device 51, when a motion prediction and compensation process in the inter-template process mode of the multi-reference frame is to be performed, the encoder 551 obtains the search center in the next reference frame by using the motion vector information obtained in the reference frame that is one frame before in the time axis, and performs a motion search by using the search center. As a result, it is possible to realize the reduction in the number of computations while minimizing a decrease in the coding efficiency.

Therefore, it is possible for the hard-disk recorder 500 to, for example, realize speed-up of processing and improve the coding efficiency of the coded data to be recorded in the hard-disk. As a result of the above, it is possible for the hard-disk recorder 500 to efficiently use the storage area of the hard-disk.

Meanwhile, in the foregoing, a description has been given of the hard-disk recorder 500 for recording video data and audio data in a hard-disk. Of course, any recording medium may be used. The image coding device 51 and the image decoding device 101 can be applied to even a recorder in which, for example, a recording medium other than a hard-disk, such as a flash memory, an optical disc, or a video tape, is used.

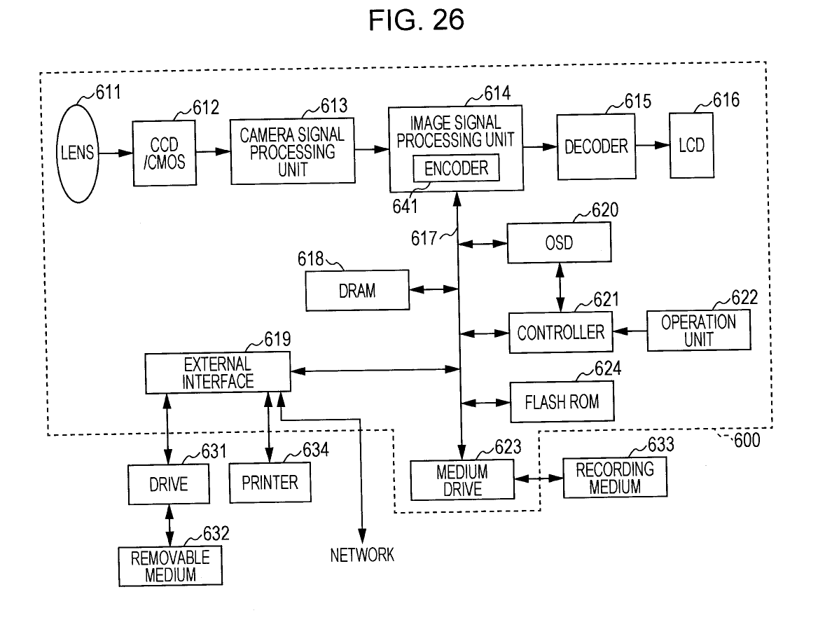

FIG. 26 is a block diagram illustrating an example of the main configuration of a camera that uses an image decoding device and an image coding device to which the present invention is applied.

A camera 600 shown in FIG. 26 captures an image of a subject, causes the image of the subject to be displayed on an LCD 616, and records the image as image data on a recording medium 633.

A lens block 611 causes light (that is, the video of the subject) to enter a CCD/CMOS 612. The CCD/CMOS 612 is an image sensor using CCDs or CMOSes, converts the strength of the received light into an electrical signal, and supplies the electrical signal to a camera signal processing unit 613.

The camera signal processing unit 613 converts the electrical signal supplied from the CCD/CMOS 612 into color-difference signals of Y, Cr, and Cb, and supplies them to an image signal processing unit 614. Under the control of the controller 621, the image signal processing unit 614 performs predetermined image processing on the image signal supplied from the camera signal processing unit 613, and codes the image signal by using an encoder 641 in accordance with, for example, the MPEG method. The image signal processing unit 614 supplies the coded data that is generated by coding the image signal to the decoder 615. In addition, the image signal processing unit 614 obtains the data for display generated in an on-screen display (OSD) 620, and supplies the data for display to the decoder 615.

In the above processing, the camera signal processing unit 613 uses, as appropriate, a DRAM (Dynamic Random Access Memory) 618 connected through a bus 617, and causes the DRAM 618 to hold image data, coded data obtained by coding the image data, and the like as necessary.

The decoder 615 decodes the coded data supplied from the image signal processing unit 614, and supplies the obtained image data (decoded image data) to the LCD 616. Furthermore, the decoder 615 supplies the data for display supplied from the image signal processing unit 614 to the LCD 616. The LCD 616 combines, as appropriate, the image of the decoded image data supplied from the decoder 615 and the image of the data for display, and displays the combined image.

Under the control of the controller 621, the on-screen display 620 outputs a menu screen containing symbols, characters, or figures, and data for display, such as icons, to the image signal processing unit 614 through the bus 617.

The controller 621 performs various processing in accordance with a signal indicating the content instructed by the user by using an operation unit 622, and also controls the image signal processing unit 614, the DRAM 618, an external interface 619, the on-screen display 620, a medium drive 623, and the like through the bus 617. The flash ROM 624 has stored therein programs, data, and the like that are necessary for the controller 621 to perform various processing.

For example, it is possible for the controller 621 taking the place of the image signal processing unit 614 and the decoder 615 to code the image data stored in the DRAM 618 and to decode the coded data stored in the DRAM 618. At this time, the controller 621 may perform a coding and decoding process in accordance with a method similar to the coding and decoding method for the image signal processing unit 614 and the decoder 615, and may perform a coding and decoding process in accordance with a method that is not supported by the image signal processing unit 614 and the decoder 615.

Furthermore, for example, in a case where the starting of image printing is instructed from the operation unit 622, the controller 621 reads image data from the DRAM 618, and supplies the image data to a printer 634 connected to the external interface 619 through the bus 617, the image data being printed by the printer 634.

In addition, for example, in a case where image recording is instructed from the operation unit 622, the controller 621 reads coded data from the DRAM 618, supplies the coded data to the recording medium 633 loaded into the medium drive 623 through the bus 617, the coded data being stored on the recording medium 633.

The recording medium 633 is, for example, an arbitrary readable and writable removable medium, such as a magnetic disc, a magneto-optical disc, an optical disc, or a semiconductor memory. Of course, the type of the recording medium 633 as a removable medium is as desired, and may be a tape device, a disc, or a memory card. Of course, the recording medium may also be a non-contact IC card or the like.

Furthermore, the medium drive 623 and the recording medium 633 may be integrated, and may also be configured by, for example, a non-portable storage medium like a built-in hard-disk drive, an SSD (Solid State Drive), and the like.

The external interface 619 is constituted by, for example, a USB input/output terminal, and is connected to the printer 634 in a case where the printing of an image is performed. Furthermore, the drive 631 is connected to the external interface 619 as necessary, and the removable medium 632, such as a magnetic disc, an optical disc, or a magneto-optical disc, is loaded thereinto. A computer program read therefrom is installed into a flash ROM 624 as necessary.

In addition, the external interface 619 includes a network interface connected to a predetermined network, such as a LAN or the Internet. The controller 621, for example, reads coded data from the DRAM 618 in accordance with instructions from the operation unit 622, and can cause the coded data to be supplied from the external interface 619 to another device connected through the network. Furthermore, the controller 621 obtains, through the external interface 619, coded data and image data that are supplied from another device through the network, and can cause the coded data and the image data to be held in the DRAM 618 and to be supplied to the image signal processing unit 614.

The camera 600 such as that described above uses the image decoding device 101 as the decoder 615. Therefore, similarly to the case of the image decoding device 101, when a motion prediction and compensation process in the inter-template process mode of the multi-reference frame is to be performed, the decoder 615 obtains the search center in the next reference frame by using the motion vector information obtained in the reference frame that is one frame before in the time axis, and performs a motion search by using the search center. As a result, it is possible to realize the reduction in the number of computations while minimizing a decrease in the coding efficiency.

Therefore, it is possible for the camera 600 to realize speed-up of processing and generate a prediction image having high accuracy. As a result of the above, it is possible for the camera 600 to, for example, obtain a higher accuracy decoded image from the image data generated in the CCD/CMOS 612, the coded data of the video data read from the DRAM 618 or the recording medium 633, and the coded data of the video data that is obtained through the network, and possible to display the decoded image on the LCD 616.

Furthermore, the camera 600 uses the image coding device 51 as the encoder 641. Therefore, similarly to the case of the image coding device 51, when a motion prediction and compensation process in the inter-template process mode of the multi-reference frame is to be performed, the encoder 641 obtains the search center in the next reference frame by using the motion vector information obtained in the reference frame that is one frame before in the time axis, and performs a motion search by using the search center. As a result, it is possible to realize the reduction in the number of computations while minimizing a decrease in the coding efficiency.

Therefore, it is possible for the camera 600 to, for example, realize speed-up of processing, and possible to the coding efficiency of the coded data that is recorded in the hard-disk. As a result of the above, it is possible for the camera 600 to efficiently use the DRAM 618 and the storage area of the recording medium 633.

Meanwhile, the decoding method of the image decoding device 101 may be applied to the decoding process performed by the controller 621. In a similar manner, the coding method of the image coding device 51 may be applied to the coding process performed by the controller 621.

Furthermore, the image data captured by the camera 600 may be a moving image or may be a still image.

Of course, the image coding device 51 and the image decoding device 101 can be applied to devices other than the above-mentioned device and system.

### REFERENCE SIGNS LIST

image coding device, 66 lossless coding unit, 74 intra-prediction unit, 75 motion prediction and compensation unit, 76 template motion prediction and compensation unit, 77 MRF search center calculation unit, prediction image selection unit, 101 image decoding device, 112 lossless decoding unit, 121 intra-prediction unit, 122 motion prediction and compensation unit, 123 template motion prediction and compensation unit, 124 MRF search center calculation unit, 125 switch

1. An image processing apparatus comprising:
a search center calculation unit that uses a motion vector of a first target block of a frame, the motion vector being searched for in a first reference frame of the first target block, so as to calculate a search center in a second reference frame whose distance to the frame in the time axis is next close to the first reference frame; and
a motion prediction unit that searches for a motion vector of the first target block by using a template that is adjacent to the first target block in a predetermined position relationship and that is generated from a decoded image in a predetermined search range in the surroundings of the search center in the second reference frame, the search center being calculated by the search center calculation unit.

2. The image processing apparatus according to claim 1, wherein the search center calculation unit calculates the search center in the second reference frame by performing scaling on the motion vector of the first target block using the distance in the time axis to the frame, the motion vector being searched for by the motion prediction unit in the first reference frame.

3. The image processing apparatus according to claim 2,
wherein, when a distance in the time axis between the frame and the first reference frame of a reference picture number ref_id=k−1 is denoted as tₖ₋₁, a distance between the frame and the second reference frame of a reference picture number ref_id=k is denoted as tₖ, and a motion vector of the first target block searched for by the motion prediction unit in the first reference frame is denoted as tmmvₖ₋₁, the search center calculation unit calculates a search center mv_{c} as
$${mv}_{c} = \frac{{t}_{k}}{{t}_{k - 1}} \cdot {tmmv}_{k - 1} , \qquad [ Math . 10 ]$$
and
wherein the motion prediction unit searches for the motion vector of the first target block using the template in a predetermined search range in the surroundings of the search center mv_{c} in the second reference frame, the search center being calculated by the search center calculation unit.

4. The image processing apparatus according to claim 3,
wherein the search center calculation unit performs a calculation of the search center mv_{c} by only a shift operation by approximating a value of tₖ/tₖ₋₁ in the form of N/2^{M} (N and M are integers).

5. The image processing apparatus according to claim 3, wherein a POC (Picture Order Count) is used as distances tₖ and tₖ₋₁ in the time axis.

6. The image processing apparatus according to claim 3,
wherein, when there is no parameter corresponding to the reference picture number ref_id in image compression information, processing is performed starting with a reference frame in the order of closeness to the frame in the time axis for both the forward and backward predictions.

7. The image processing apparatus according to claim 2,
wherein the motion prediction unit searches for the motion vector of the first target block in a predetermined range by using the template in the first reference frame whose distance in the time axis to the frame is closest.

8. The image processing apparatus according to claim 2,
wherein, when the second reference frame is a long term reference picture, the motion prediction unit searches for the motion vector of the first target block in a predetermined range by using the template in the second reference frame.

9. The image processing apparatus according to claim 2, further comprising:
a decoding unit that decodes information on a coded motion vector; and
a prediction image generation unit that generates a prediction image by using the motion vector of a second target block of the frame, the motion vector being decoded by the decoding unit.

10. The image processing apparatus according to claim 2,
wherein the motion prediction unit searches for the motion vector of a second target block of the frame by using the second target block, and
wherein the image processing apparatus further comprises an image selection unit that selects one of a prediction image based on the motion vector of the first target block, the motion vector being searched for by the motion prediction unit, and a prediction image based on the motion vector of the second target block, the motion vector being searched for by the motion prediction unit.

11. An image processing method comprising the steps of:
using, with an image processing apparatus, a motion vector of a target block, the motion vector being searched for in a first reference frame of the target block of a frame, so as to calculate a search center in a second reference frame whose distance in the time axis to a frame is next close to the first reference frame; and
searching for, with the image processing apparatus, a motion vector of the target block in a predetermined search range in the surroundings of the calculated search center in the second reference frame by using a template that is adjacent to the target block in a predetermined position relationship and that is generated from a decoded image.
